(19) United States
(12) Patent Application Publication
(10) Pub. No.: US 2026/0181506 A1
(43) Pub. Date: Jun. 25, 2026

(54) METHOD AND APPARATUS FOR LARGE DATA TRANSMISSION

(71) Applicant: ELECTRONICS AND TELECOMMUNICATIONS RESEARCH INSTITUTE, Daejeon (KR)

(72) Inventor: Jun Sik KIM, Daejeon (KR)

(73) Assignee: ELECTRONICS AND TELECOMMUNICATIONS RESEARCH INSTITUTE, Daejeon (KR)

(21) Appl. No.: 19/410,379

(22) Filed: Dec. 5, 2025

(30) Foreign Application Priority Data
Dec. 5, 2024 (KR) 10-2024-0179355
Dec. 4, 2025 (KR) 10-2025-0190880

(51) Int. Cl. H04W 36/30; H04W 36/00

(52) U.S. Cl. CPC H04W 36/30; H04W 36/0055

(57) ABSTRACT

Disclosed are large-capacity data transmission methods and apparatuses. A method of a terminal may comprise: transmitting a measurement report to a first base station; receiving, from the first base station, first cluster configuration information generated based on the measurement report; and performing communication with the first base station based on a first cluster configured by the first cluster configuration information.

### CROSS-REFERENCE TO RELATED APPLICATIONS

This application claims priority to Korean Patent Applications No. 10-2024-0179355, filed on Dec. 5, 2024, and No. 10-2025-0190880, filed on Dec. 4, 2025, with the Korean Intellectual Property Office (KIPO), the entire contents of which are hereby incorporated by reference.

### BACKGROUND

### 1. Technical Field

The present disclosure relates to an enhanced communication technique, and more particularly, to a large-capacity data transmission technique.

### 2. Related Art

A communication network (e.g. 5G communication network, 6G communication network, and the like) for providing improved communication services compared to an existing communication network (e.g. long term evolution (LTE), LTE Advanced (LTE-A), and the like) is being developed. The 5G communication network (e.g. new radio (NR) communication network) can support frequency bands of 6 GHz or lower as well as frequency bands above 6 GHz. In other words, the 5G communication network can support frequency range 1(FR1 ) and/or frequency range 2(FR2 ). The 5G communication network can support various communication services and scenarios compared to the LTE communication network. For example, usage scenarios of the 5G communication network may include enhanced Mobile Broadband (eMBB), Ultra-Reliable Low Latency Communication (URLLC), and massive Machine Type Communication (mMTC).

When communication is performed in an ultra-high frequency band, radio waves used for communication may have strong directionality. Radio waves having strong directionality may suffer large path loss. Accordingly, communication in the ultra-high frequency band may be used only in limited fields. In order to compensate for disadvantages of communication in the ultra-high frequency band, multi-transmission and reception point (TRP)-based beamforming technology may be introduced. In a communication environment in which multi-TRP-based beamforming is performed, cell-centric radio access rather than user-centric radio access may be performed. The cell-centric radio access may not flexibly respond to changes in a reception environment due to movement of a terminal. To address the above-described problem, a large-capacity data transmission method according to the present disclosure may be required as a terminal-centric radio access scheme.

### SUMMARY

The present disclosure for resolving the above-described problems is directed to providing methods and apparatuses for large-capacity data transmission.

A method of a terminal, according to exemplary embodiments of the present disclosure, may comprise: transmitting a measurement report to a first base station; receiving, from the first base station, first cluster configuration information generated based on the measurement report; and performing communication with the first base station based on a first cluster configured by the first cluster configuration information.

The method may further comprise: performing communication with the first base station based on a second cluster before transmitting the measurement report, wherein the measurement report includes cluster performance measurement results of the second cluster.

The cluster performance measurement results may include at least one of: channel quality information of a channel between the terminal and each of transmission and reception points (TRPs) belonging to the second cluster, or a frequency of occurrence of beam-level handovers occurring in an area of the second cluster.

The first cluster configuration information may include at least one of: a cluster identifier of the first cluster, a group of TRPs included in the first cluster, a group of distributed units (DUs) included in the first cluster, an uplink (UL) transmission mode, or a multi-connectivity technique applied to the first cluster.

The cluster identifier may include at least one of: a central unit-control plane (CU-CP) identifier, a central unit-user plane (CU-UP) identifier, or a DU group identifier.

The UL transmission mode may indicate one of a duplicated transmission mode, a multi-path transmission mode, or a single-path transmission mode.

The method may further comprise: performing communication with the first base station based on a second cluster using a second UL transmission mode before transmitting the measurement report, wherein the first cluster configuration information includes a first UL transmission mode, and a switching from the second UL transmission mode to the first UL transmission mode is determined by the first base station based on the measurement report.

The performing of the communication with the first base station may comprise: performing transmission mode configuration based on a UL transmission mode indicated by the first cluster configuration information; performing uplink data scheduling for TRPs belonging to the first cluster based on transmission priorities among the TRPs; and performing communication with the first base station via the TRPs based on the uplink data scheduling.

The method may further comprise: performing communication with the first base station based on a second cluster including a second CU-UP before transmitting the measurement report, wherein the first cluster configuration information includes information on a first CU-UP, and the first CU-UP is determined based on the measurement report.

The method may further comprise: performing communication with the first base station based on a second cluster including a second DU before transmitting the measurement report, wherein the first cluster configuration information includes information on a first DU, and the first DU is determined based on the measurement report.

The method may further comprise: transmitting cluster performance measurement results of the first cluster to the first base station; receiving third cluster configuration information from the first base station; and performing a handover to a third base station including a third DU indicated by the third cluster configuration information.

A method of a first base station, according to exemplary embodiments of the present disclosure, may comprise: receiving a measurement report from a terminal; determining first cluster configuration information based on the measurement report; transmitting the first cluster configuration information to the terminal; and performing communication with the terminal based on a first cluster configured by the first cluster configuration information.

The method may further comprise: performing communication with the terminal based on a second cluster before receiving the measurement report, wherein the measurement report includes performance measurement results of the second cluster.

The cluster performance measurement results may include at least one of: channel quality information of a channel between the terminal and each of transmission and reception points (TRPs) belonging to the second cluster, or a frequency of occurrence of beam-level handovers occurring in an area of the second cluster.

The first cluster configuration information may include at least one of: a cluster identifier of the first cluster, a group of TRPs included in the first cluster, a group of distributed units (DUs) included in the first cluster, an uplink (UL) transmission mode, or a multi-connectivity technique applied to the first cluster.

The cluster identifier may include at least one of: a central unit-control plane (CU-CP) identifier, a central unit-user plane (CU-UP) identifier, or a DU group identifier.

The UL transmission mode may indicate one of a duplicate transmission mode, a multi-path transmission mode, or a single-path transmission mode.

The method may further comprise: performing communication with the terminal based on a second cluster using a second UL transmission mode before receiving the measurement report; and determining, based on the measurement report, a switching from the second UL transmission mode to a first UL transmission mode, wherein the first cluster configuration information includes the first UL transmission mode, and communication based on the first cluster is performed based on the first UL transmission mode.

The method may further comprise: performing communication with the terminal based on a second cluster including a second distributed unit (DU) before receiving the measurement report; and determining, based on the measurement report, a change from the second DU to a first DU, wherein the first cluster configuration information includes information on the first DU.

The method may further comprise: receiving cluster performance measurement results of the first cluster from the terminal; determining whether to perform a handover based on the measurement report; and transmitting, to a second base station, a handover request including cluster information of the first cluster based on the determination of whether to perform the handover.

According to the present disclosure, a terminal can transmit a measurement report to a network. The network can determine a cluster, a multi-connectivity technique to be applied to the cluster, and a transmission mode based on the measurement report. The network can transmit cluster configuration information to the terminal. The network can perform cluster update based on cluster performance measurement values periodically received. The network can transmit, to the terminal, cluster configuration information for configuring an updated cluster. Through the above-described procedure, signaling overhead can be reduced when supporting mobility of the terminal. Through the above-described procedure, large-capacity data can be transmitted and received between the terminal and the network.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3A is a conceptual diagram illustrating exemplary embodiments of a cluster cell.

FIG. 3B is a conceptual diagram illustrating exemplary embodiments of a cluster cell.

FIG. 4 is a conceptual diagram illustrating exemplary embodiments of multiple TRPs.

FIG. 5A is a conceptual diagram illustrating exemplary embodiments of protocol stacks.

FIG. 5B is a conceptual diagram illustrating exemplary embodiments of protocol stacks.

FIG. 6A is a conceptual diagram illustrating exemplary embodiments of L2 layer SDUs and PDUs.

FIG. 6B is a conceptual diagram illustrating exemplary embodiments of L2 layer SDUs and PDUs.

FIG. 7 is a conceptual diagram illustrating exemplary embodiments of a terminal-centric cell.

FIG. 8 is a conceptual diagram illustrating types of user-plane multi-connectivity techniques.

FIG. 9A is a conceptual diagram illustrating exemplary embodiments of network slices.

FIG. 9B is a conceptual diagram illustrating exemplary embodiments of network slices.

FIG. 10 is a conceptual diagram illustrating exemplary embodiments of a cluster including a function-split base station.

FIG. 11 is a conceptual diagram illustrating exemplary embodiments of a cluster including a function-split base station.

FIG. 12 is a conceptual diagram illustrating exemplary embodiments of a function-split base station including a CU-CP and CU-UPs.

FIG. 13A is a conceptual diagram illustrating exemplary embodiments of a protocol stack of a terminal-centric cluster.

FIG. 13B is a conceptual diagram illustrating exemplary embodiments of a protocol stack of a terminal-centric cluster.

FIG. 14 is a conceptual diagram illustrating exemplary embodiments of a protocol stack of a terminal-centric cluster.

FIG. 15 is a conceptual diagram illustrating exemplary embodiments of a protocol stack of a terminal-centric cluster.

FIG. 16A is a conceptual diagram illustrating exemplary embodiments of multi-PDCP-based protocol layer mapping.

FIG. 16B is a conceptual diagram illustrating exemplary embodiments of multi-PDCP-based protocol layer mapping.

FIG. 17 is a conceptual diagram illustrating exemplary embodiments of a multi-PDCP structure.

FIG. 18A is a conceptual diagram illustrating exemplary embodiments of a multi-PDCP-based PDU structure.

FIG. 18B is a conceptual diagram illustrating exemplary embodiments of a multi-PDCP-based PDU structure.

FIG. 19A is a flowchart illustrating exemplary embodiments of a communication method based on a terminal-centric cluster.

FIG. 19B is a flowchart illustrating exemplary embodiments of a communication method based on a terminal-centric cluster.

FIG. 19C is a flowchart illustrating exemplary embodiments of a communication method based on a terminal-centric cluster.

FIG. 20A is a sequence diagram illustrating exemplary embodiments of a communication method based on a terminal-centric cluster.

FIG. 20B is a sequence diagram illustrating exemplary embodiments of a communication method based on a terminal-centric cluster.

FIG. 21A is a sequence diagram illustrating exemplary embodiments of a cluster change procedure.

FIG. 21B is a sequence diagram illustrating exemplary embodiments of a cluster change procedure.

FIG. 22A is a sequence diagram illustrating exemplary embodiments of a communication method based on a terminal-centric cluster.

FIG. 22B is a sequence diagram illustrating exemplary embodiments of a communication method based on a terminal-centric cluster.

FIG. 22C is a sequence diagram illustrating exemplary embodiments of a communication method based on a terminal-centric cluster.

FIG. 23A is a sequence diagram illustrating exemplary embodiments of a CU-UP switching procedure.

FIG. 23B is a sequence diagram illustrating exemplary embodiments of a CU-UP switching procedure.

FIG. 23C is a sequence diagram illustrating exemplary embodiments of a CU-UP switching procedure.

FIG. 24A is a sequence diagram illustrating exemplary embodiments of a DU changing procedure.

FIG. 24B is a sequence diagram illustrating exemplary embodiments of a DU changing procedure.

FIG. 24C is a sequence diagram illustrating exemplary embodiments of a DU changing procedure.

FIG. 25A is a sequence diagram illustrating exemplary embodiments of a handover procedure.

FIG. 25B is a sequence diagram illustrating exemplary embodiments of a handover procedure.

FIG. 25C is a sequence diagram illustrating exemplary embodiments of a handover procedure.

FIG. 25D is a sequence diagram illustrating exemplary embodiments of a handover procedure.

FIG. 26A is a flowchart illustrating exemplary embodiments of a UL transmission mode configuration procedure.

FIG. 26B is a flowchart illustrating exemplary embodiments of a UL transmission mode configuration procedure.

FIG. 26C is a flowchart illustrating exemplary embodiments of a UL transmission mode configuration procedure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

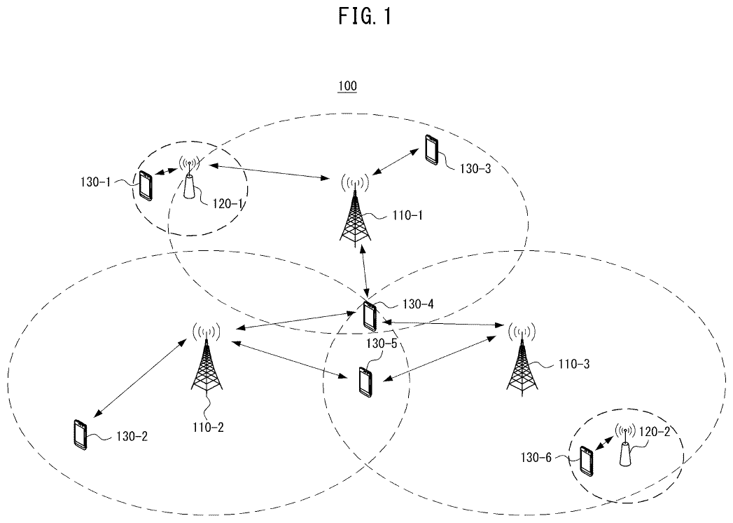

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have a structure below.

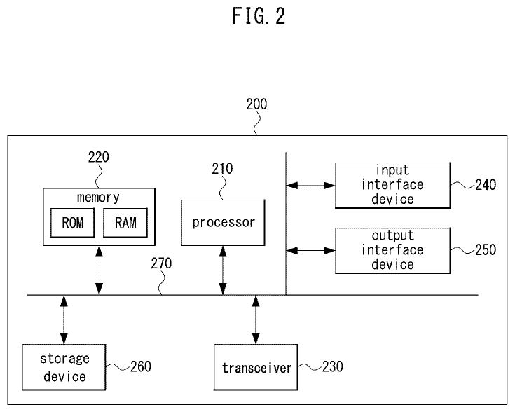

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

### Limitations of High-Frequency Band Communication

When communication is performed in a high-frequency band, a capacity of a communication system can be increased. However, signals transmitted and received in the high-frequency band may have high directivity and large propagation loss. Such properties of the signals may cause difficulty in cell formation. Therefore, high-frequency band communication may be applied only in limited fields (e.g. in-device communication, short-range peer-to-peer (P2P) communication, data centers, and wireless backhaul).

In order to address the above-described difficulty in cell formation, multi-antenna-based beamforming technology may be introduced. Through the multi-antenna-based beamforming, ultra-narrow beams having a small beam width may be formed. Through introduction of the beamforming technology, a radio access scheme may be changed from cell-centric radio access to terminal-centric radio access.

The present disclosure proposes radio access node-based cell formation, simplification of a transmission procedure for large-capacity data transmission, and procedures for controlling terminal-centric cloud operations. Due to service areas of narrow beams, frequent beam switching may occur, and an outage due to handover may increase. Therefore, when a cloud area is changed, the above-described issues may be addressed through operations of an access node group and a terminal-centric transmission scheme.

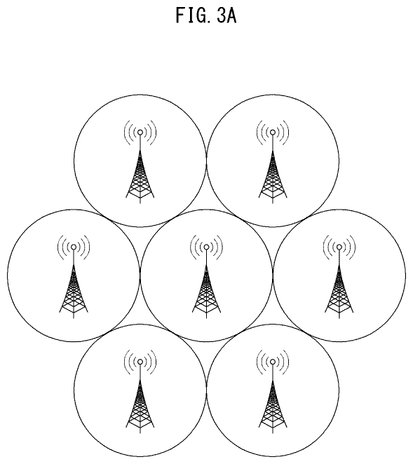

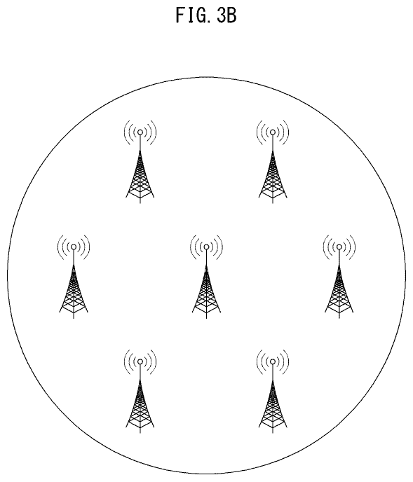

FIG. 3A and FIG. 3B are conceptual diagrams illustrating exemplary embodiments of a cluster cell.

Referring to FIG. 3A, base station(s) may form cells. Cell-centric radio access may be identified. Referring to FIG. 3B, cells formed in a high-frequency band (hereinafter, referred to as ‘high-frequency cells’) may be identified. The cells may be logically regarded as a single cell. A plurality of base stations (or TRPs) may form a single logical cell. For example, in a dense urban area with base stations, a plurality of base stations may form a single logical cell.

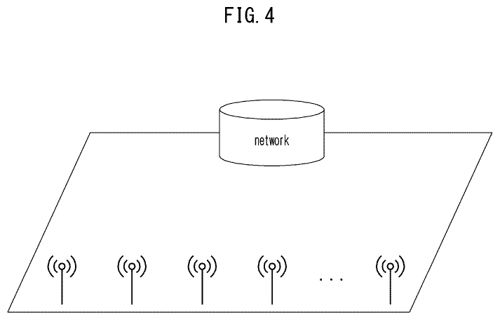

FIG. 4 is a conceptual diagram illustrating exemplary embodiments of multiple TRPs.

Referring to FIG. 4, a network (e.g. a central unit (CU) or a core network) may determine an optimal TRP set according to movement of a terminal. TRPs included in the optimal TRP set may provide a serving cell to the terminal. The network may not associate any one TRP with the terminal such that the terminal is located at a center of the cell. A high-frequency cell may support initial access of the terminal and inter-cell mobility. The high-frequency cell may be used to provide a synchronization signal and system information to the terminal. The network may control a plurality of TRPs to form a terminal-centric cell area. The plurality of TRPs may operate resources used to form beams such that the terminal-centric cell area is formed.

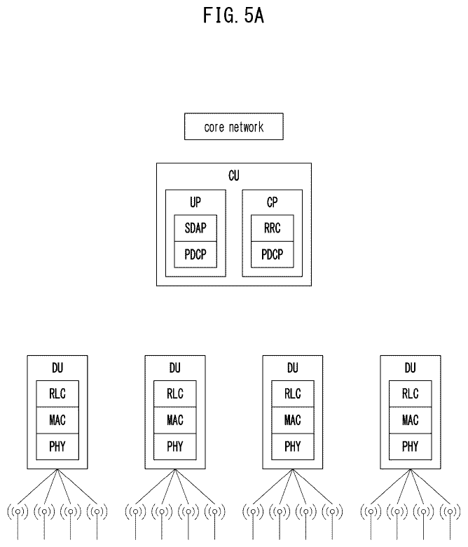

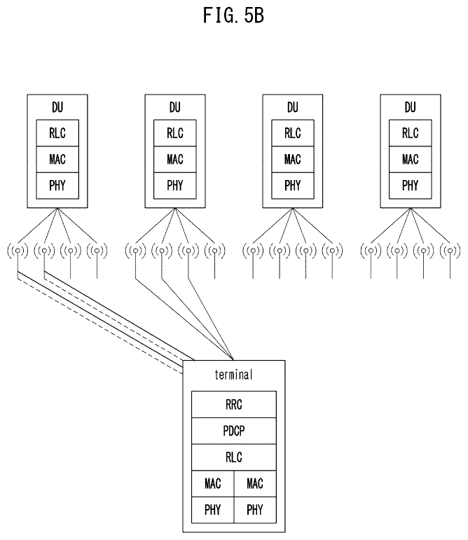

FIG. 5A and FIG. 5B are conceptual diagrams illustrating exemplary embodiments of protocol stacks.

Referring to FIG. 5A and FIG. 5B, protocol stacks of a function-split base station and a protocol stack of a terminal may be identified. The function-split base station may include a CU and a plurality of distributed units (DUs) (or TRPs). Each DU may control a plurality of TRPs (or remote radio heads (RRHs)). A dotted line may indicate a path through a control plane. A solid line may indicate a path through a user plane.

The protocol stack may be composed of a plurality of layers. The layers may be classified into an L1 layer, an L2 layer, and an L3 layer according to technical specifications. The L1 layer may perform physical signal processing. The L2 layer may control radio resources and perform data transmission and matching. The L3 layer may perform control functions (e.g. radio connection management, mobility management, and QoS management).

The L1 layer may be a physical (PHY) layer. The L1 layer may provide functions for data delivery. The L2 layer may be composed of a media access control (MAC) layer, a radio link control (RLC) layer, a packet data convergence protocol (PDCP) layer, and a service data adaptation protocol (SDAP) layer. The L3 layer may be a radio resource control (RRC) layer. The L3 layer may provide control functions of an access stratum (AS) layer.

The base station may be functionally composed of a CU, DU(s), and radio unit(s) (RU(s)). Each RU may include a TRP. The base station to which the functional-split scheme is applied may be logically split into the CU and DU(s).

The CU may be a logical node that performs functions of the RRC layer, SDAP layer, and PDCP layer. The CU may control one or more DUs. The CU may be connected to a core network through a backhaul link based on an S1 interface or an NG interface. The DU may be a logical node that performs functions of some layers among the RLC layer, MAC layer, and PDCP layer of the base station. The DU may operate one or more cells. The CU and the DU may be connected through an F1 interface via wired or wireless communication.

The DU may be connected to a TRP through an Fx interface (e.g. fronthaul) via wired or wireless communication. An access point (AP) may be implemented as a TRP or an RRH. A TRP may perform both downlink transmission and uplink reception. Alternatively, a TRP may perform only downlink transmission or only uplink reception.

The AP may be configured to perform only RF functions. The AP may be configured to perform some functions of a DU (e.g. PHY layer and MAC layer). When functions performed by the AP include some functions of a DU, the AP may be configured to perform lower functions of the PHY layer. Alternatively, when functions performed by the AP include some functions of a DU, the AP may be configured to perform all functions of the PHY layer and some functions of the MAC layer. The AP may be a node whose role varies depending on functions that the AP is configured to perform.

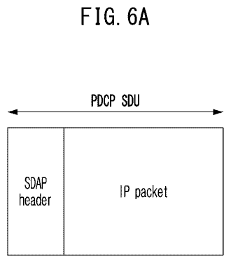

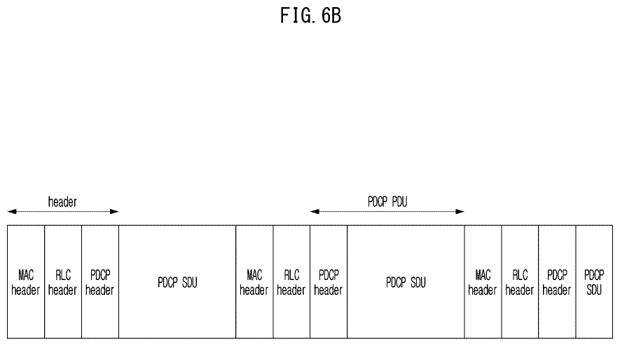

FIG. 6A and FIG. 6B are conceptual diagrams illustrating exemplary embodiments of L2 layer SDUs and PDUs.

Referring to FIG. 6A and FIG. 6B, each layer belonging to the L2 layer may generate a protocol data unit (PDU) by adding a header to a service data unit (SDU) delivered from an upper layer. The generated PDU may be converted into a transport block in the MAC layer. The transport block may be delivered to the L1 layer. Headers may be repeatedly added at the respective layers. Therefore, in a communication environment in which large-capacity data is transmitted, excessive overhead may occur due to cumulatively added headers.

According to the functional-split scheme, layers belonging to the base station may be separated. In a communication environment including the base station to which the functional-split scheme is applied (hereinafter, referred to as a ‘function-split base station’), a 1:N relationship may be established between a CU and DUs. Methods for managing one CU and a plurality of DUs corresponding to the one CU may be required. In order to integrally manage split functions of TRPs performing access with the terminal, a centralized function (e.g. CU-control plane (CU-CP)) may be required. In addition, in order to transmit large-capacity data, a distributed CU-user plane (CU-UP) structure may be required. Through the above-described function split, DUs may be grouped. Through grouping of DUs, an amount of information transmitted and received may be reduced. Transmission and reception of information may occur due to movement of the terminal. The present disclosure proposes methods of splitting a CU into CU-CP and CU-UP in a terminal-centric wireless communication environment in which a DU group is dynamically formed according to movement of the terminal. The present disclosure provides methods of forming a terminal-centric cluster (hereinafter, referred to as a ‘cluster’) according to movement of the terminal. The present disclosure provides a UL transmission mode control method for operating the cluster.

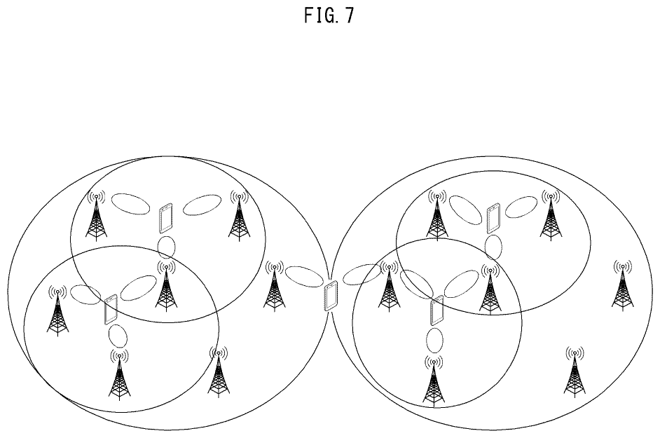

FIG. 7 is a conceptual diagram illustrating exemplary embodiments of a terminal-centric cell.

Referring to FIG. 7, a terminal-centric cell may include a plurality of TRPs (or a plurality of base stations) connected through an ideal backhaul link or a non-ideal backhaul link. The cell may be configured with fine beams. A scenario in which the cell is configured may not be limited to a cloud radio access network (CRAN) or an ideal backhaul environment. The ideal backhaul environment may refer to a backhaul environment having almost no delay due to a very high backhaul transmission rate. A scenario in which the cell is configured may be extended to a scenario in which a plurality of TRPs cooperating through centralized control of the network form the cell. Each of the plurality of TRPs (or the plurality of base stations) that form the terminal-centric cell may include a plurality of protocol entities (e.g. SDAP entity, PDCP entity, RLC entity, and MAC entity).

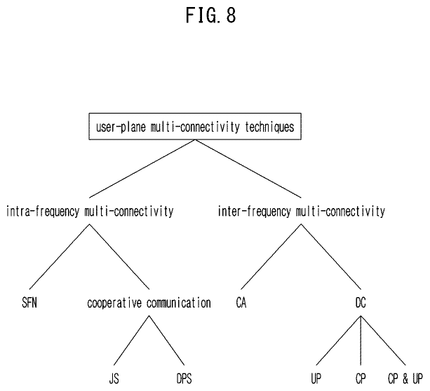

FIG. 8 is a conceptual diagram illustrating types of user-plane multi-connectivity techniques.

A high-frequency band may have the following advantages. A high-frequency band may provide a wide bandwidth, a continuous bandwidth, and a high directivity. A high-frequency band may enable miniaturized antennas. A high-frequency band may have the following disadvantages. A signal transmitted and received in a high-frequency band may have a high signal attenuation rate. When a signal attenuation rate is high, a signal coverage distance may be short. When a signal attenuation rate is high, signal blocking due to an obstacle may occur. In order to overcome the above-described disadvantages of high-frequency band communication, multi-connectivity between base stations or between different radio access technologies (RATs) may be required. Multi-connectivity may mean that a terminal forms (or maintains) a plurality of links with various types of base stations (or TRPs).

Referring to FIG. 8, multi-connectivity techniques for communication in a user plane may be classified based on a configuration of frequencies applied to a communication system. Intra-frequency multi-connectivity may refer to connectivity in the same frequency band. Inter-frequency multi-connectivity may refer to connectivity between different frequency bands.

The intra-frequency multi-connectivity techniques may include single frequency network (SFN) and cooperative communication. The cooperative communication may be coordinated multi point (CoMP) communication. The CoMP communication may include joint transmission (JT) CoMP and dynamic point selection (DPS) CoMP.

A plurality of base stations may synchronize signals transmitted from the plurality of base stations such that, in order to implement SFN, the signals are received at the terminal within a cyclic prefix (CP) duration of an OFDM symbol. When the plurality of base stations perform broadcast transmission or multicast transmission, the plurality of base stations may transmit signals by using the same modulation and coding scheme (MCS) and the same radio resources without channel information between the terminal and the plurality of base stations. When the plurality of base stations perform transmission for a specific terminal, the plurality of base stations may receive a beam report from the terminal. The plurality of base stations may select base stations based on the beam report. The selected base stations may perform transmission for the specific terminal by using the same MCS and the same radio resources. The terminal may restore data by combining signals received from the plurality of base stations. The terminal may prevent data loss due to signal blocking caused by an obstacle by combining the signals received from the plurality of base stations.

When JT CoMP is performed, the terminal may measure reference signals received through beams from a plurality of base stations. The terminal may report, to the plurality of base stations, base station identifier(s), beam identifier(s), and channel state information based on measurement results. The plurality of base stations performing JT CoMP may determine weights of the plurality of base stations, respectively. The plurality of base stations may perform transmission for the terminal by using the same MCS and the same radio resources based on the weights of the plurality of base stations, respectively. When JT CoMP is performed, even when transmission of a certain beam is blocked due to an obstacle, a signal may be transmitted to the terminal through another beam. Therefore, signal blocking due to an obstacle may be mitigated.

When DPS CoMP is performed, a plurality of base stations may select base stations and beams that are most suitable when performing transmission for a terminal based on channel information reported from the terminal. The channel information may be channel information of a channel between each of the plurality of base stations and the terminal. The plurality of base stations may perform transmission for the terminal by using the selected base stations and the selected beams. Even when blocking due to an obstacle occurs in a serving beam, beam switching may be rapidly performed to a beam radiated from another base station. Service continuity and mobility of the terminal may be supported due to beam switching.

In order to realize the intra-frequency multi-connectivity techniques, a scheduler may adjust an MCS, transmission resources, and a transmission scheme. For the adjustment by the scheduler, a common MAC layer may be required. In order to synchronize between TRPs, a transmission delay from a terminal to each of the TRPs may be small.

A high-frequency band may support a wide bandwidth. Therefore, the high-frequency band may be divided into a plurality of carrier frequencies. A plurality of RATs may be implemented by applying different numerologies according to requirements of a service. In addition, a RAT having a frequency band of 6 GHz or below and a RAT belonging to a high-frequency band may cooperate to configure a network.

Inter-frequency multi-connectivity techniques may include carrier aggregation (CA) and dual connectivity (DC). DC may be implemented as a combination of different RATs. CA may be a technique of transmitting and receiving data by using two or more carrier frequencies. Since a high-frequency band provides a wide frequency band, the high-frequency band may be divided into a plurality of carrier frequencies. By using the plurality of carrier frequencies, a RAT suitable for large-capacity traffic transmission and various service types may be configured.

DC may be a technique proposed to improve performance of a small cell. In a DC environment, a macro cell and a micro cell connected through an X2 interface may transmit data simultaneously. Integration of two cells may be achieved by a serving gateway (S-GW). The integration of two cells may be performed at a PDCP layer. In the PDCP layer, a plurality of RAT connections may be integrated. A user-plane controller of the PDCP layer may perform data storage, distribution, and adjustment between base stations. The user-plane controller may guarantee sequential transmission of received data packets.

When data is simultaneously transmitted through different RATs, an amount of traffic transmitted may be controlled based on transmission bandwidth and transmission delay between RATs. By controlling the amount of traffic transmitted, delay may not occur when data is transmitted.

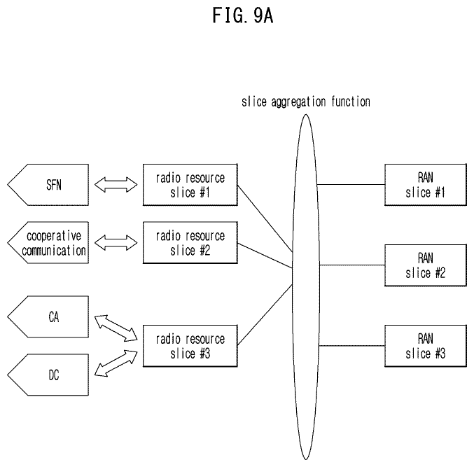

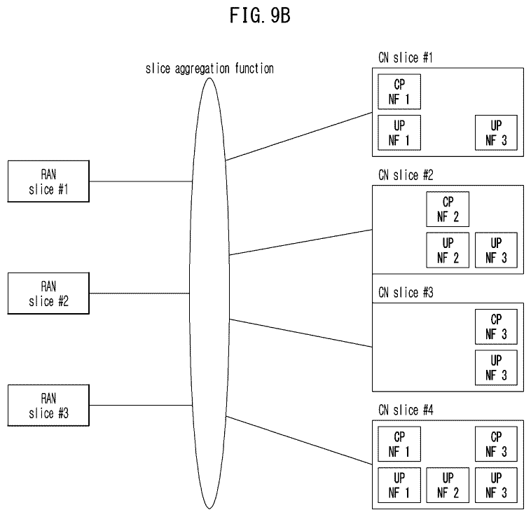

FIG. 9A and FIG. 9B are conceptual diagrams illustrating exemplary embodiments of network slices.

Referring to FIG. 9A and FIG. 9B, network slices may be identified as a network is implemented as software. Implementation of a network as software may be an important step in a network evolution process. Implementation of a network as software may be separation of hardware and software on a common physical network infrastructure. By using software defined network (SDN) and network function virtualization (NFV) technologies, various logical (or virtual) networks may be configured according to service scenarios or business models. The above-described logical network or virtual network may be referred to as a network slice. A network slice may be a logical network designed according to a business requirement.

Network slices may be proposed for an NR core network. The network slices may dynamically configure a virtualized core network through SDN and NFV technologies for a business purpose. An NR RAN may be designed with a flexible structure to accommodate network slices having various purposes. The NR RAN may be designed to allocate resources to match characteristics or functions of each of network slices.

Considering a purpose of supporting network slices, an RAN may be designed such that utilization of resources is maximized. On one physical network infrastructure, a plurality of network slices may be simultaneously configured according to a service scenario or a business purpose. Each of the plurality of network slices may be operated as an independent network on the same physical network infrastructure. The RAN may be designed such that the plurality of network slices efficiently share radio resources and links.

For example, for a network slice in which variation in a data transmission rate is not large and low latency and ultra-reliability are required, a scheme of fixedly allocating independent radio resources may be advantageous. For a network slice in which variation in a data transmission rate is large and burst characteristics exist, a scheme of allocating dedicated resources respectively may be inefficient. Therefore, for a network slice having burst characteristics, a scheme in which shared resources are configured and resources are dynamically allocated through a scheduling mechanism may be appropriate. In RAN design, a resource allocation and scheduling mechanism may be considered to match traffic characteristics required for each network slice.

In order to identify a network slice, a core network may support a quality of service (QoS) scheme. There may be a need to review whether a QoS scheme can be commonly applied to all network slices in an RAN without identification of the network slices. For example, when an RAN schedules shared radio resources, different priorities may be given for the respective network slices. In order to give different priorities for the respective network slices, identification information for identifying each network slice may be required. In order to give priorities according to traffic types of network slices, a traffic type discrimination mechanism may be required. A scheduler of an RAN may allocate resources based on priorities of the respective network slices.

When a plurality of network slices share the same radio resources, a method of minimizing interference between the network slices may be required. For example, a protection mechanism between the network slices may be required such that, even when traffic congestion occurs in a network slice, quality of another network slice is not degraded.

According to requirements of a network slice (e.g. mobility of a terminal, a traffic pattern, and latency and jitter), an infrastructure management mechanism may be required such that a network slice can be created, changed, and deleted, and interface design between an RAN and a core network may be required.

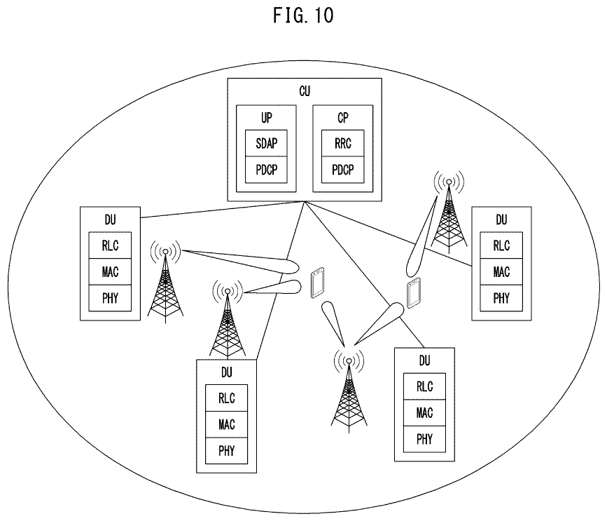

FIG. 10 is a conceptual diagram illustrating exemplary embodiments of a cluster including a function-split base station.

Referring to FIG. 10, a high-frequency-based communication system may use an antenna array for radiating beams. When a terminal moves, beam directivity may change. When beam directivity changes, a beam service area, signal quality, and channel quality may change. Signal blocking due to an obstacle may easily occur. A beam service area may be narrow. Beam-level handovers may frequently occur.

As a method for addressing the above-described problems, a cluster scheme may be used. The cluster scheme may not affect a core network and may support mobility of a terminal. A cluster may include a CU, a plurality of DUs, and a plurality of TRPs. The cluster may provide services for a terminal. In another example, a cluster may include a CU-CP, a CU-UP, a plurality of DUs (e.g. a DU group), and a plurality of TRPs (e.g. a TRP group). A cell formed by the cluster may be referred to as a cluster cell. A cell area formed by the cluster cell may be referred to as a cluster area.

The terminal may move within the cluster area. When movement of the terminal within the cluster occurs, a beam-level handover may be performed only through signaling between nodes included in the cluster without signaling between the terminal and the cluster. The cluster may be configured based on a location of the terminal. According to movement of the terminal, nodes included in the cluster may be dynamically added to or removed from the cluster.

The cluster may configure a TRP or a DU included in the cluster as a node for access with the terminal (hereinafter, referred to as an ‘access node’). The TRP configured as the access node may be referred to as a reference TRP. The DU configured as the access node may be referred to as a reference DU. Through access node configuration, the cluster may perform a beam-level handover (or inter-TRP handover) according to movement of the terminal. The access node may be connected to the core network. The access node may be connected to other nodes included in the cluster. A cluster configuration may vary according to a distance between each of TRPs included in the cluster and the terminal and a channel quality between each of the TRPs and the terminal. The cluster configuration may be configuration of which nodes (e.g. DUs and TRPs) are included in the cluster.

When the cluster uses a transmission link having a limited bandwidth, an upper-layer function-split-based cluster may be configured. The upper-layer function-split-based cluster may be as follows. A CU may include layers less sensitive to latency (e.g. RRC layer), and DUs may include a latency-sensitive L2 layer and an L1 layer. The upper-layer function-split-based cluster may be classified into a distributed-mode cluster and a centralized-mode cluster.

The distributed-mode cluster may configure an access node among nodes included in the cluster. When beam switching is performed to a TRP other than the reference TRP (or DU), the reference TRP may forward data to the TRP. The data forwarding may be performed at the RLC layer or the MAC layer. The centralized-mode cluster may configure one DU among DUs included in the cluster as a reference TRP. TRPs may receive data from the CU. The CU may deliver data processed at the PDCP layer to a TRP that transmits a beam to the terminal.

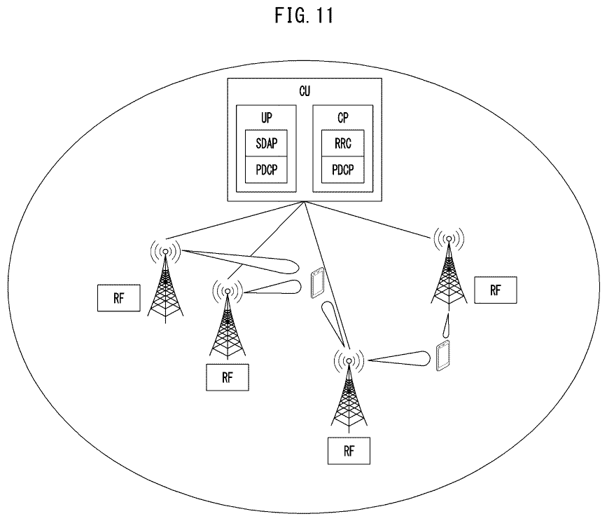

FIG. 11 is a conceptual diagram illustrating exemplary embodiments of a cluster including a function-split base station.

Referring to FIG. 11, an RRH-based cluster may be identified. The RRH-based cluster may split functions of a base station into a CU and RU(s). The CU may process all protocol functions on a control plane and a user plane. A TRP may perform an RU function. The TRP may perform RF processing like an RRH.

A terminal may measure a reference signal received through a beam. The terminal may report optimal TRP(s) and a beam list to the CU based on measurement results. The CU may determine TRP(s) and a beam that provide a service to the terminal based on the report of the terminal. The TRP may perform analog beamforming. The TRP may receive beam weights from the CU. When signal attenuation and propagation blocking occur, the CU may rapidly perform beam switching to another TRP. The reference TRP may continuously manage TRPs and beams that the terminal can use.

Cluster management may refer to addition or removal of TRPs included in the cluster according to movement of the terminal after the cluster is configured. The terminal may measure quality of the beam. The terminal may report beam quality to the reference TRP (or DU) through a beam report. The reference TRP may determine change of the reference TRP and addition or removal of TRP(s) based on the beam report.

Mobility support for the terminal within the cluster may be achieved through beam switching. The reference TRP may determine whether beam-level switching or intra-beam switching is required based on the beam report received from the terminal. When measured signal quality or signal blocking due to an obstacle is detected, the scheduler may rapidly perform switching to an adjacent beam.

When a TRP (or DU) that receives the measurement report from the terminal determines that beam-level switching is required, the TRP (or DU) may deliver the measurement report to the reference TRP. The reference TRP may transmit a beam switching request to a target TRP. The reference TRP may receive a response from the target TRP. The target TRP may notify a TRP providing a serving beam of completion of switching. The terminal may receive data through a beam provided by the target TRP.

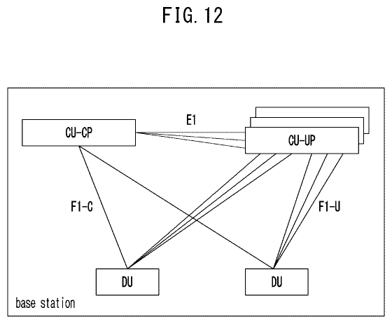

FIG. 12 is a conceptual diagram illustrating exemplary embodiments of a function-split base station including a CU-CP and CU-UPs.

Referring to FIG. 12, a CU may be split into a CU-CP and a plurality of CU-UPs. E1 interfaces between the CU-CP and the CU-UPs may be defined. An F1-C interface may be defined between the CU-CP and a DU. F1-U interfaces may be defined between the CU-UPs and a DU.

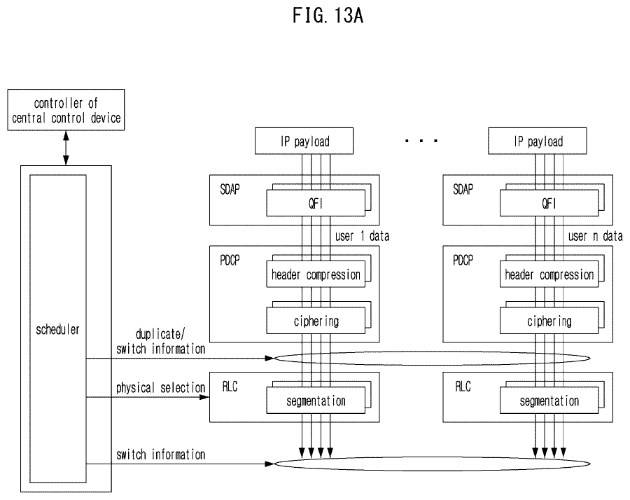

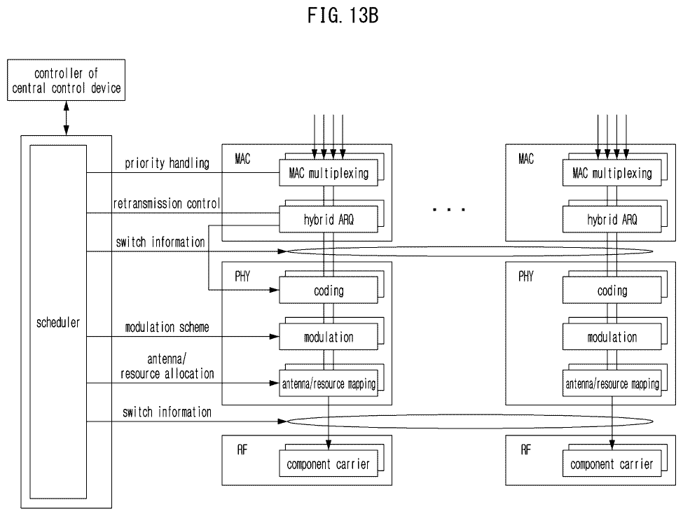

FIG. 13A and FIG. 13B are conceptual diagrams illustrating exemplary embodiments of a protocol stack of a terminal-centric cluster.

Referring to FIG. 13A and FIG. 13B, protocol stacks of a cluster may be identified in a communication environment in which functions of a base station are split. According to an instruction of a central control device, configuration of the protocol stacks may be flexibly changed based on a switching function. In a context in which the protocol stack appears, switching may refer to determining, within the protocol stack, which TRP provides service to the terminal, which PDCP-distribute (PDCP-D) delivers data to a lower layer, and which beam and resource are used. In other words, in a context in which the protocol stack appears, switching may refer to reconfiguring a transmission path ‘PDCP→RLC→MAC→PHY’ based on cluster management. The transmission path may be one of a data path and a control information path. Switching may be required for the following reasons. According to movement of the terminal, a TRP to which the terminal is connected may be changed. According to cluster management, TRPs included in the cluster may be added or removed. Mapping from PDCP-central (PDCP-C) to PDCP-D may be changed according to movement of the terminal. The RLC layer, the MAC layer, and the PHY layer may be changed with respect to which DU (or TRP) the layers are connected to, according to movement of the terminal.

For flexible change of the protocol stack, a protocol header may include information related to the cluster (e.g. switching information). A protocol entity may flexibly select which access node is to be used in order to configure or manage the cluster.

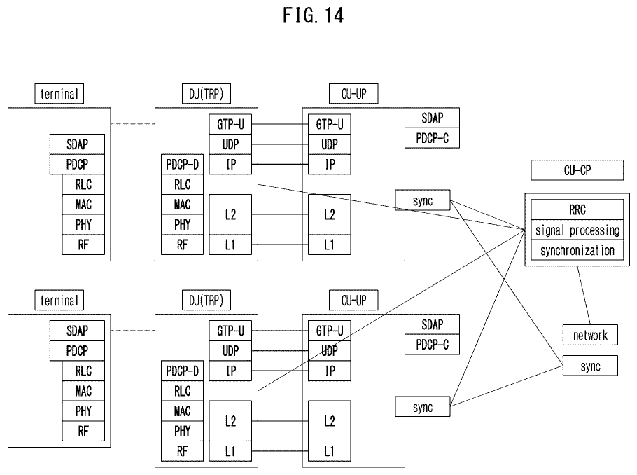

FIG. 14 is a conceptual diagram illustrating exemplary embodiments of a protocol stack of a terminal-centric cluster.

Referring to FIG. 14, the CU-CP may generate a transmission path in the function-split base station. The CU-CP may perform signal processing and synchronization for protocol control. The CU may be split into the CU-CP and CU-UP(s). Alternatively, the CU-CP and the CU-UP may exist in one node.

The CU-CP may manage the CU-UPs and the cluster. The cluster may include DUs and RUs. The CU-CP may generate a transmission path. The CU-CP may control mapping and switching between protocol entities belonging to different layers. The CU-CP may control processing of signals transmitted to the terminal through the generated transmission path. In order to guarantee data transmission through multiple paths and data integrity, data may be transmitted in a duplicate manner. A PDCP function may be split into a PDCP-C and a PDCP-D for duplicate transmission of data. Through splitting of the PDCP function, duplicate transmission of data for data integrity may be performed.

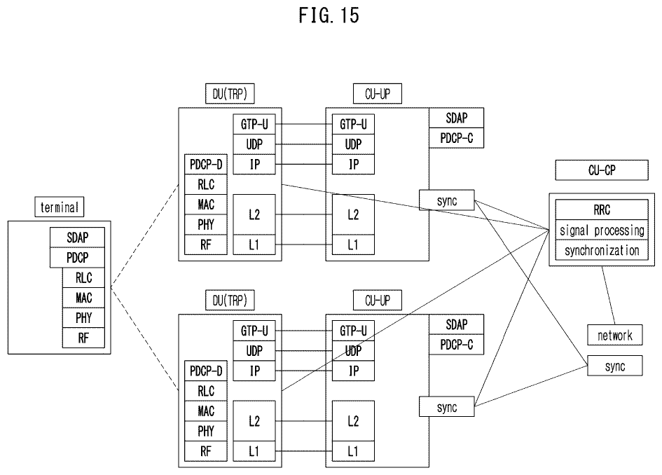

FIG. 15 is a conceptual diagram illustrating exemplary embodiments of a protocol stack of a terminal-centric cluster.

Referring to FIG. 15, an extended protocol stack of the protocol stack illustrated in FIG. 14 may be identified. A cluster may be composed of a set of nodes (e.g. DUs and TRPs) connected to one CU. In addition, the cluster may include a plurality of base stations. Accordingly, a plurality of CUs may be included in the cluster. Multi-connectivity techniques may be applied to the plurality of CUs.

A CU-CP may perform signal processing and synchronization in order to generate a transmission path and perform protocol control in a function-split base station. The CU may be split into the CU-CP and CU-UP(s). Alternatively, the CU may exist as one node. The CU-CP may manage or configure the cluster including DUs and RUs. The CU-CP may generate a transmission path. The CU-CP may perform mapping between protocol entities belonging to different layers. The CU-CP may perform switching between protocol entities belonging to different layers.

In order to guarantee data transmission through multiple paths and data integrity, data may be transmitted in the duplicated manner. A PDCP function may be split into a PDCP-C and a PDCP-D for duplicate transmission of data. Through splitting of the PDCP function, duplicate transmission of data for data integrity may be performed.

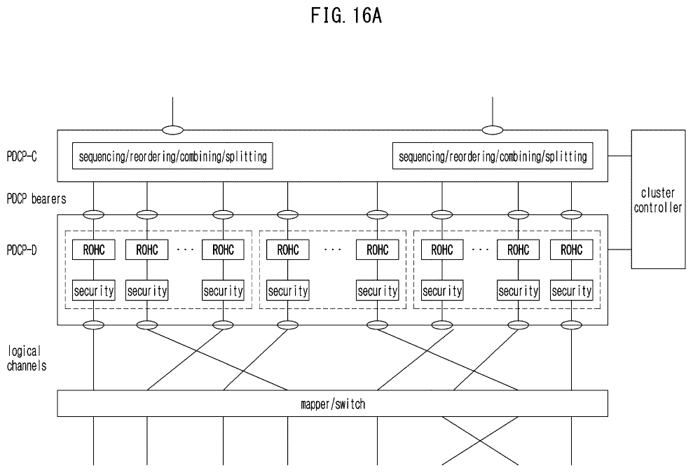

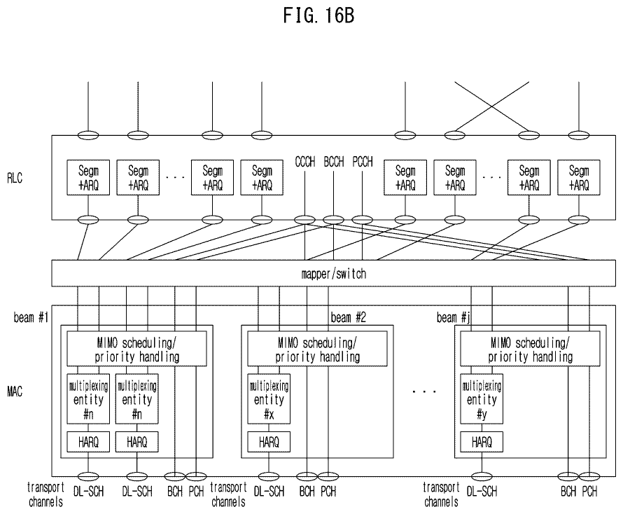

FIG. 16A and FIG. 16B are conceptual diagrams illustrating exemplary embodiments of multi-PDCP-based protocol layer mapping.

Referring to FIG. 16A and FIG. 16B, in a multi-connectivity environment, managing data according to an applied multi-connectivity technique may be required to guarantee data integrity. Duplicate transmission of data to TRPs (or DUs), reordering of received data, and sequencing of data may be required. Data may be transmitted through a plurality of function-split base stations. Therefore, protocol entities belonging to different layers within the L2 layer may be flexibly connected to each other. Since protocol entities belonging to different layers within the L2 layer are flexibly connected, bearers and channels may be flexibly managed. To guarantee data integrity, a retransmission operation may be performed by the cluster according to an instruction of the central control device. Each of protocol layers and protocol entities may manage logical channel information. Information on PDUs corresponding to a logical channel may be delivered to the central control device and related protocol entities.

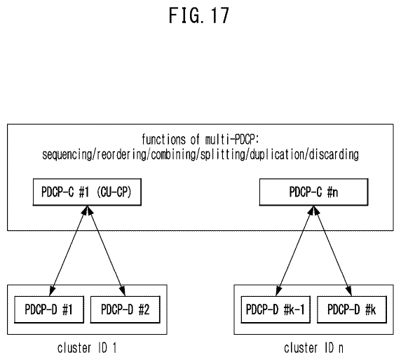

FIG. 17 is a conceptual diagram illustrating exemplary embodiments of a multi-PDCP structure.

Referring to FIG. 17, a PDCP-C entity included in a CU may be connected to a plurality of PDCP-D entities included in DUs. The PDCP-D entity may perform processing (e.g. compression) for IP packets among functions belonging to the PDCP layer. The PDCP-C entity may perform reordering, sequencing, combining, and splitting for IP packets delivered through the PDCP-D entities. Sequencing may be assigning numbers to IP packets to determine an order among the IP packets.

A PDCP group may include the PDCP-C entity and a plurality of PDCP-D entities. The PDCP group may be distinguished by a cluster ID. The cluster ID may be used as a field constituting a header.

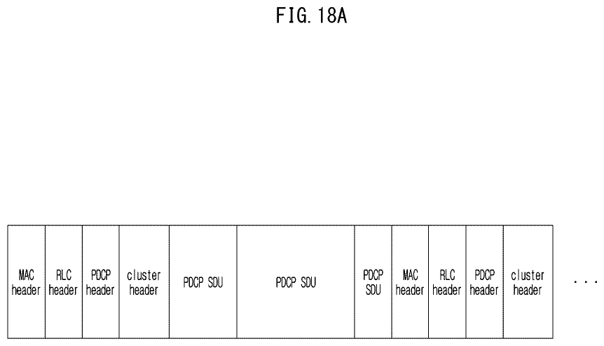

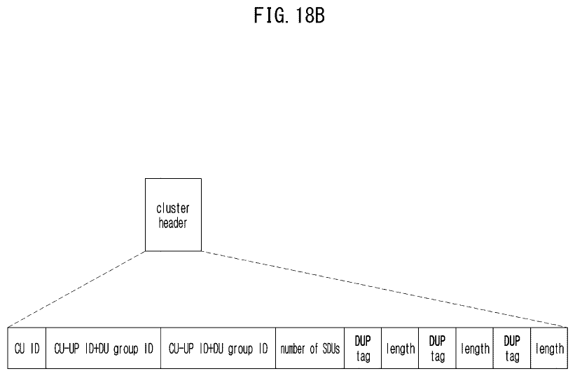

FIG. 18A and FIG. 18B are conceptual diagrams illustrating exemplary embodiments of a multi-PDCP-based PDU structure.

Referring to FIG. 18A and FIG. 18B, to reduce header overhead occurring in the L2 layer, the PDCP-C entity may combine a plurality of IP packets having the same QoS flow to generate one PDCP SDU. A cluster header may be a header assigned by the PDCP-C entity for cluster-level data processing in the multi-PDCP-based transmission environment. The cluster header may be composed of a cluster ID and information included in the PDCP SDU. The cluster ID may be composed of a CU ID and one or more DU group IDs.

A PDCP PDU having the same PDCP header structure may include at least one of information on a number of current PDCP SDUs, a tag indicating whether each of the PDCP SDUs is a target of duplicate transmission, or length information of each of the PDCP SDUs.

Compared to a scheme of adding a separate L2 header to each IP packet, the above-described header adding scheme may reduce L2 overhead per IP packet. This is because a plurality of IP packets can be attached to one PDCP SDU. Reduction of L2 overhead per IP packet can increase transmission efficiency and transmission capacity in large-capacity data transmission.

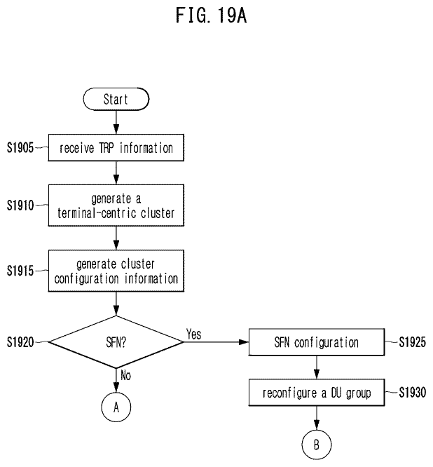

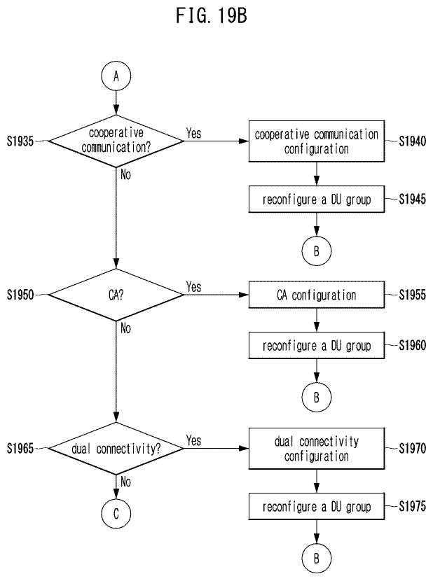

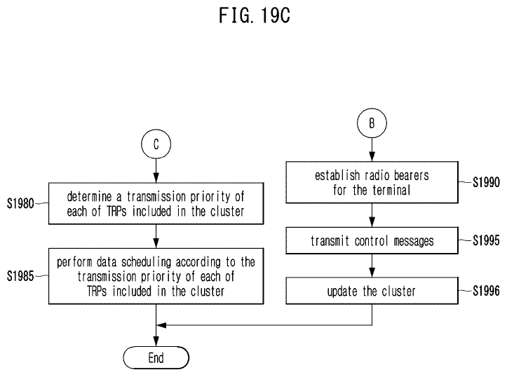

FIG. 19A to FIG. 19C are flowcharts illustrating exemplary embodiments of a communication method based on a terminal-centric cluster.

Referring to FIG. 19A to FIG. 19C, a cluster configuration procedure by the base station (or the network or the CU-CP) may be identified. The base station may receive, from the terminal, a measurement report including TRP information (S1905). The TRP information may include channel quality information (e.g. reference signal received power (RSRP), reference signal received quality (RSRQ), etc.) between each TRP adjacent to the terminal and the terminal. The base station may configure or manage a cluster based on the TRP information. A cluster controller may be involved in configuration and management of the cluster.

The base station may determine a multi-connectivity technique (e.g. SFN, cooperative communication, or dual connectivity) to be used for transmission through the cluster based on the TRP information. The base station may generate a DU group including one or more DUs and a TRP group including one or more TRPs based on the selected multi-connectivity technique. The base station may determine a cluster including at least one of the CU-UP, the DU group, or the TRP group (S1910). The base station may generate a cluster ID identifying the determined cluster. After determining the cluster, the base station may determine a reference TRP (or reference DU). The base station may generate cluster configuration information based on the determined cluster. The base station may transmit the cluster configuration information to the terminal. The cluster configuration information may indicate at least one of the cluster ID, the group(s) (e.g. DU group, TRP group) including nodes included in the cluster, CU-UP, a transmission mode (e.g. UL transmission mode), or the multi-connectivity technique applied to the cluster.

The base station may determine whether the multi-connectivity technique to be applied is SFN (S1920). When the multi-connectivity technique to be applied is determined as SFN, the base station may perform SFN configuration (S1925). When the SFN configuration is completed, the base station may reconfigure a DU group (or TRP group) corresponding to SFN (S1930). The base station may determine whether the multi-connectivity technique to be applied is cooperative communication (S1935). When the multi-connectivity technique to be applied is determined as cooperative communication, the base station may perform cooperative communication configuration (S1940). When the cooperative communication configuration is completed, the base station may reconfigure a DU group (or TRP group) corresponding to cooperative communication (S1945). The base station may determine whether the multi-connectivity technique to be applied is CA (S1950). When the multi-connectivity technique to be applied is determined as CA, the base station may perform CA configuration (S1955). When the CA configuration is completed, the base station may reconfigure a DU group (or TRP group) corresponding to CA (S1960). The base station may determine whether the multi-connectivity technique to be applied is dual connectivity (S1965). When the multi-connectivity technique to be applied is determined as dual connectivity, the base station may perform dual connectivity configuration (S1970). When the dual connectivity configuration is completed, the base station may reconfigure a DU group (or TRP group) corresponding to dual connectivity (S1975).

After completing configuration corresponding to the multi-connectivity technique to be applied and reconfiguration of a DU group corresponding to the multi-connectivity technique to be applied, the base station may establish radio bearer(s) for the terminal (S1990). The base station may transmit, to the terminal, cluster configuration information including at least one of the reconfigured cluster ID, the reconfigured TRP group, the reconfigured DU group, the reconfigured CU-UP, a transmission mode (e.g. DL transmission mode), or the multi-connectivity technique applied to the cluster (S1995). The cluster configuration information may be transmitted through an RRC reconfiguration message. The base station may update an existing cluster to a new cluster by transmitting the cluster configuration information (S1996).

When application of the multi-connectivity technique is difficult, the base station may determine transmission priorities among TRPs belonging to the cluster based on channel quality information included in the measurement report (S1980). The base station may perform data scheduling according to the transmission priorities (S1985). The data scheduling may refer to at least one of determining through which TRP data is transmitted, determining at which time data is transmitted, or determining how much data is transmitted.

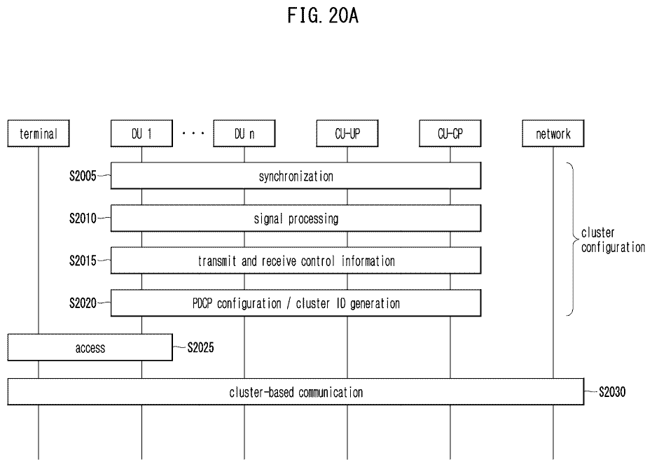

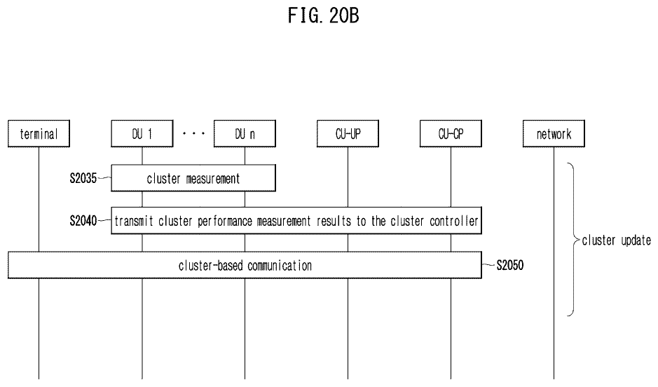

FIG. 20A and FIG. 20B are sequence diagrams illustrating exemplary embodiments of a communication method based on a terminal-centric cluster.

Referring to FIG. 20A and FIG. 20B, a step of configuring a cluster, a step of performing cluster access and cluster-based communication, and a step of updating the cluster may be identified. A central control device (e.g. cluster controller) may be included in the CU-CP. A network may be a core network.

The step of configuring a cluster may be as follows. Synchronization between DUs (e.g. DU 1 to DU n) and the CU may be performed (S2005). The synchronization may be a procedure for the DUs and the CU to perform communication with a terminal through a multi-connectivity technique. The synchronization may be an adjustment procedure for sharing a symbol timing, a frame number, or a slot boundary between the DUs and the CU.

The DUs and the CU may perform signal processing (S2010). The signal processing may mean coordinating L1 or L2 signal processing roles performed by the DUs and the CU under a function-split base station structure at the cluster level. For cluster control, the DUs and the CU may transmit and receive control information (e.g. path switch or transmission mode configuration) through control signaling (S2015).

The CU and the DUs may perform PDCP configuration (S2020). The PDCP configuration may mean at least one of configuring mapping between a PDCP-C entity and PDCP-D entities, configuring a PDCP group, or configuring a transmission mode (e.g. duplicate transmission mode, multi-path transmission mode, or single-path transmission mode). The PDCP group may include PDCP-D entities. After completing the PDCP configuration, the CU-CP may generate a cluster ID corresponding to the PDCP group. The cluster ID may be composed of a CU ID, a CU-UP ID, and a DU group ID. The CU ID included in the cluster may be a CU-CP ID. When the cluster ID is generated, the cluster configuration may be completed.

The step of performing cluster-based communication may be as follows. The CU-CP may generate links among TRPs or DUs included in the cluster. For example, a fronthaul link between the reference TRP and another TRP may be generated. After generating links among the TRPs, the CU-CP may determine a transmission path. After the transmission path is determined, the CU-CP may perform synchronization among the TRPs. The CU-CP may determine the reference TRP among the TRPs belonging to the cluster. Determination of the reference TRP may include determining a transmission path between the reference TRP and a core network and determining a transmission path of ‘PDCP-C—PDCP-D—RLC—MAC’. The cluster including DUs and TRPs may perform access with a terminal through the reference TRP or a reference DU (S2025). After the above-described procedures are completed, cluster-based communication may be performed (S2030).

The step of updating the cluster may be as follows. The cluster may receive a measurement report from the terminal (S2035). The measurement report may include cluster performance measurement results (e.g. channel quality information of channels between TRPs and the terminal). TRPs (or DUs) receiving the measurement report may deliver the measurement report to the CU-CP (or cluster controller) (S2040). The CU-CP may determine a TRP group including TRPs (or DUs) capable of providing services to the terminal based on the measurement report. The CU-CP may reconfigure (or update) a cluster area based on the determined TRP group. Communication between the terminal and the base station may be performed based on the reconfigured cluster (S2050).

The terminal may move within the cluster area. According to movement of the terminal, the terminal may enter a service area of TRP #2 or DU #2 rather than a service area of TRP #1 or DU #1 that has provided a beam to the terminal. TRP #2 may receive a terminal-specific signal (e.g. sounding reference signal (SRS)) from the terminal. Based on reception of the terminal-specific signal, TRP #2 and related protocol entities may be activated.

The CU-CP may determine whether to perform split transmission or duplicate transmission through a transmission path associated with TRP #1 and a transmission path associated with TRP #2 based on at least one of channel quality of TRP #1 and TRP #2 or a location of the terminal. When split transmission is determined to be performed, the terminal may perform uplink transmission for split data through the transmission path associated with TRP #1 and the transmission path associated with TRP #2. When duplicate transmission is determined to be performed, the terminal may perform uplink transmission for the same data through the transmission path associated with TRP #1 and the transmission path associated with TRP #2.

When a channel between the terminal and TRP #1 deteriorates, transmission of data (or control information) to the terminal may be stopped. The terminal may receive data (or control information) from TRP #2 and protocol entities associated with TRP #2. Other TRPs belonging to the cluster and protocol entities associated with the other TRPs may transition to a standby state.

When data is delivered to the base station through multiple transmission paths, PDUs may be duplicated. Due to delay, an order in which PDUs arrive may not be maintained. The PDCP-C entity may remove redundant PDUs (or data) by using a duplication tag, a sequence number, or the like included in each PDU. The PDCP-C entity may restore an order according to an original sequence number through sequencing or reordering for PDUs (or data). The PDCP-C entity may deliver PDUs whose order is restored to an upper layer.

Performance of the cluster may deteriorate according to movement of the terminal. When performance of the cluster deteriorates, cluster reconfiguration or update may be triggered. The cluster reconfiguration may include at least one of change of the reference TRP (or reference DU), change of the TRP group, or change of the DU group. The cluster reconfiguration may include change of the cluster ID, change of a PDCP path, or reconfiguration of the UL transmission mode. After the cluster reconfiguration is completed, communication may be performed with a new cluster ID and a new transmission path.

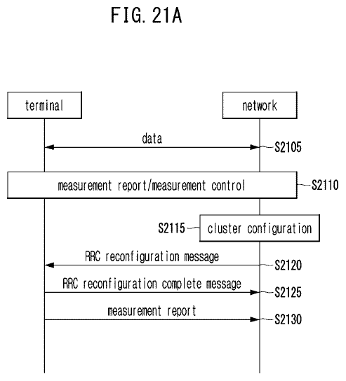

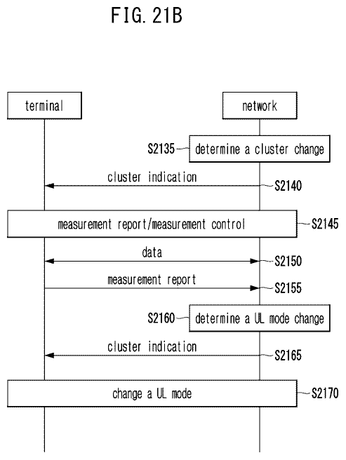

FIG. 21A and FIG. 21B are sequence diagrams illustrating exemplary embodiments of a cluster change procedure.

Referring to FIG. 21A and FIG. 21B, the terminal may be in an RRC connected state. The terminal and the network may transmit and receive data (S2105). The communication between the terminal and the network may be performed via TRP(s) (or DU(s)). In other words, information transmitted from the terminal may be delivered to the CU-CP (or cluster controller) via TRP(s) (or DU(s)). The terminal may transmit a measurement report to the network (S2110). The measurement report may include quality of channels between the terminal and TRPs adjacent to the terminal. The network may control measurement of the terminal through measurement configuration information (S2110). The network may configure a cluster based on the measurement report (S2115). The network may transmit cluster configuration information to the terminal through an RRC reconfiguration message (S2120). The cluster configuration information may include at least one of a cluster ID, a DU group/TRP group included in the cluster, a reference TRP (or DU), a CU-UP ID, a transmission mode (e.g. UL transmission mode), or a multi-connectivity technique applied to the cluster. After receiving the cluster configuration information, the terminal may transmit an RRC reconfiguration complete message to the network (S2125). The terminal may periodically transmit a measurement report to the network (S2130). The measurement report may include quality of channels between the terminal and TRPs belonging to the cluster.

The network may determine cluster change based on the measurement report (S2135). The network may transmit, to the terminal, a cluster indication (or cluster configuration information) indicating a changed cluster (S2140). The cluster indication may indicate a UL transmission mode. The UL transmission mode may be a type of transmission mode. The UL transmission mode may be one of a duplicate transmission mode, a multi-path transmission mode, or a single-path transmission mode. The terminal may periodically transmit a measurement report to the network (S2145). The network may control the measurement report through measurement configuration information (S2145). The measurement report may include quality of channels between TRPs belonging to the changed cluster and the terminal.

The network may determine change of the UL transmission mode based on the measurement report (S2160). The network may transmit a cluster indication to the terminal (S2165). The cluster indication may indicate a changed UL transmission mode. The terminal may perform communication with the network based on the changed UL transmission mode and cluster (S2170).

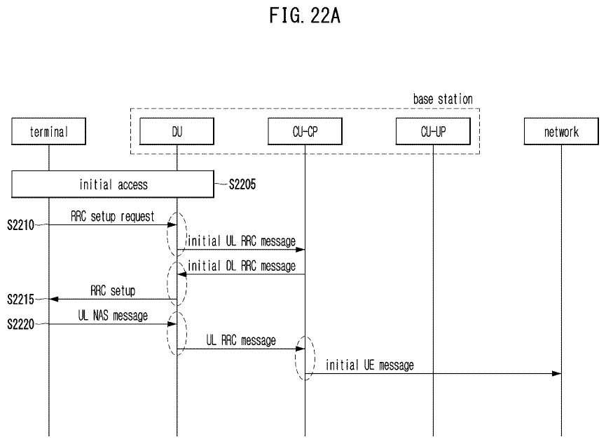

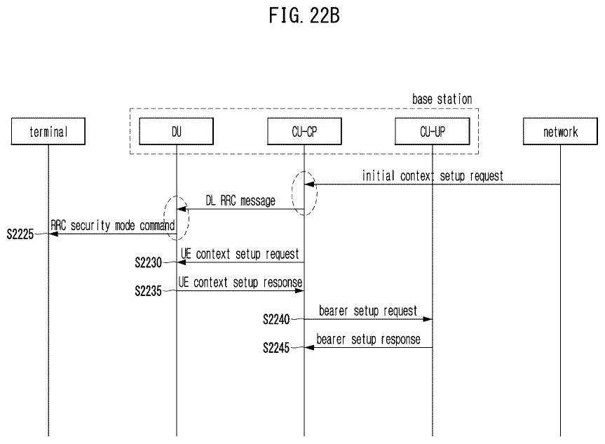

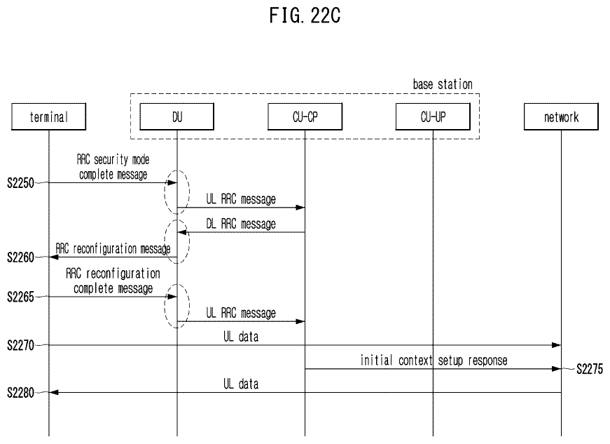

FIG. 22A to FIG. 22C are sequence diagrams illustrating exemplary embodiments of a communication method based on a terminal-centric cluster.

Referring to FIG. 22A to FIG. 22C, a procedure in which a function-split base station establishes an initial connection with a terminal may be identified. A network may be a core network. The terminal may perform an initial access procedure with a DU (S2205). After completing the initial access procedure, the terminal may transmit an RRC setup request to the DU (S2210). The DU that receives the RRC setup request may deliver an initial UL RRC message to a CU-CP (S2210). The CU-CP that receives the initial UL RRC message may determine a cluster. The CU-CP may transmit cluster configuration information to the DU based on the determined cluster (S2215). The cluster configuration information may include at least one of a cluster ID, a DU group, a TRP group, a CU-UP ID, a transmission mode (e.g. UL transmission mode), or a multi-connectivity technique applied to the cluster. The cluster configuration information may be transmitted to the DU through an initial DL RRC message. The cluster configuration information may include neighboring cell information. The neighboring cell information may indicate cells that are targets of measurement of the terminal among cells adjacent to the terminal. The neighboring cell information may be transmitted to the DU irrespective of the cluster configuration information. The DU that receives the initial DL RRC message may transmit an RRC setup message to the terminal (S2215). An RRC connection may be established between the terminal and the base station. The terminal may enter an RRC state.

The terminal may transmit a UL NAS message to the DU (S2220). After receiving the UL NAS message, the DU may deliver a UL RRC message to the CU-CP (S2220). The CU-CP that receives the UL RRC message may transmit an initial UE message to the network (S2220). After receiving the initial UE message, the network may transmit an initial context setup request to the CU-CP (S2225). The CU-CP that receives the initial context setup request may deliver a DL RRC message to the DU (S2225). The DU that receives the DL RRC message may transmit an RRC security mode command to the terminal (S2225).

The CU-CP may transmit a UE context setup request to the DU (S2230). The DU that receives the UE context setup request may transmit a UE context setup response to the CU-CP (S2235). The CU-CP that receives the UE context setup response may transmit a bearer setup request to a CU-UP (S2240). The bearer setup request may include bearer configuration information. The bearer configuration information may be based on the cluster. In other words, the bearer configuration information may be information for configuring cluster-level bearer(s) reflecting at least one of the cluster ID, the DU group, the TRP group, or the transmission mode. The bearer configuration information may include at least one of the cluster ID, a type of a multi-connectivity technique applied to communication between the cluster and the terminal, a transmission mode (e.g. DL transmission mode or UL transmission mode), or transmission priorities among TRPs belonging to the cluster. The CU-UP that receives the bearer setup request may establish bearer(s) based on the bearer configuration information. The CU-UP that receives the bearer setup request may transmit a bearer setup response to the CU-CP (S2245).

The terminal may transmit an RRC security mode complete message to the DU (S2250). The DU that receives the RRC security mode complete message may deliver a UL RRC message to the CU-UP (S2250). The CU-CP that receives the UL RRC message may transmit a DL RRC message to the DU (S2260). The DU that receives the DL RRC message may transmit an RRC reconfiguration message to the terminal (S2260). The terminal that receives the RRC reconfiguration message may transmit an RRC reconfiguration complete message to the DU (S2265). The DU that receives the RRC reconfiguration complete message may deliver a UL RRC message to the CU-CP (S2265). The terminal may transmit UL data to the network based on the cluster (S2270). The CU-CP may transmit an initial context setup response to the network (S2275). The network that receives the initial context setup response may transmit DL data to the terminal based on the cluster (S2280).

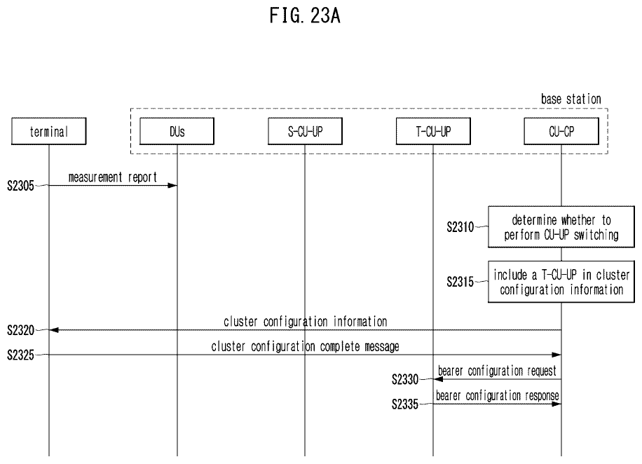

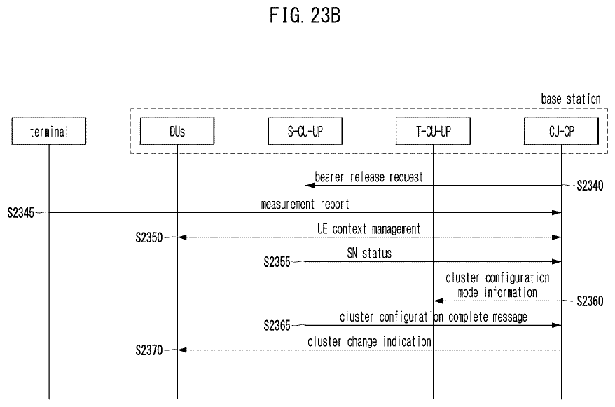

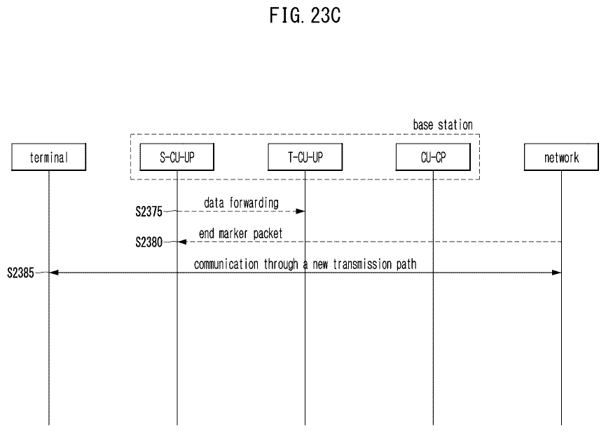

FIG. 23A to FIG. 23C are sequence diagrams illustrating exemplary embodiments of a CU-UP switching procedure.

Referring to FIG. 23A to FIG. 23C, a procedure in which a CU-UP providing service to a terminal based on a cluster is switched from a source (S)-CU-UP to a target (T)-CU-UP may be identified. A network may be a core network. The terminal may perform communication based on the cluster with the base station or the network. The CU-CP may change DUs providing service to the terminal by changing a transmission path on the CU-UP. The CU-CP may support mobility of the terminal by changing DUs providing service to the terminal.

The terminal may transmit a measurement report to the DUs (S2305). The measurement report may include cluster performance measurement results. The cluster performance measurement results may include a value indicating quality in a cluster perspective (e.g. quality of a channel between TRPs belonging to the cluster and the terminal, or a frequency at which beam switching occurs within the cluster). The DUs may deliver the measurement report to the CU-CP. The CU-CP may determine whether to switch the CU-UP based on the measurement report (S2310). When the CU-CP determines switching of the CU-UP, the CU-CP may determine a T-CU-UP among CU-UPs corresponding to the CU-CP.

The CU-CP may transmit, to the terminal, cluster configuration information including the T-CU-UP (S2315, S2320). The cluster configuration information may include at least one of a cluster ID, a TRP group, a DU group, a CU-UP ID, a transmission mode (e.g. UL transmission mode), or a multi-connectivity technique applied to the cluster. The CU-UP indicated by the cluster configuration information may be the T-CU-UP. The cluster configuration information may be transmitted through an RRC reconfiguration message. The terminal that receives the cluster configuration information may transmit a cluster configuration complete message to the CU-CP (S2325). The terminal may perform synchronization with the changed DUs based on the cluster configuration information.

The CU-CP may transmit at least one of the cluster configuration information or a bearer configuration request to the T-CU-UP (S2330). The T-CU-UP that receives the bearer configuration request may perform bearer configuration based on the cluster configuration information. The T-CU-UP that completes bearer configuration may transmit a bearer configuration response to the CU-CP (S2335). The CU-CP may transmit a bearer release request to the S-CU-UP (S2340). The S-CU-UP may transmit, to the CU-CP, at least one of a CU-UP configuration state or data forwarding information in response to the bearer release request. The CU-UP configuration state may include state information on how the CU-UP has configured a transmission path for the terminal.

The terminal may transmit a measurement report to the CU-CP (S2345). The CU-CP may configure a new UE context for the terminal based on at least one of the bearer configuration state included in the bearer configuration response received from the T-CU-UP, or a CU-UP configuration state received from the S-CU-UP. The CU-CP and DUs may perform UE context management according to the new UE context (S2350). The S-CU-UP may transmit a sequence number (SN) status to the CU-CP (S2355). The SN status may be state information on how far a PDCP transmission entity and a PDCP reception entity have currently performed data processing.

The CU-CP may transmit cluster configuration mode information to the T-CU-UP (S2360). The cluster configuration mode information may include at least one of a transmission mode (e.g. UL transmission mode or DL transmission mode), a CU-UP configuration state, data forwarding information, or the SN status. The information included in the cluster mode information may be information obtained by the CU-CP from the S-CU-UP. The cluster configuration mode may be information for operating the cluster. The transmission mode may be a transmission mode applied to the cluster. Through the cluster configuration mode information, the T-CU-UP may immediately operate the cluster according to the cluster mode. The S-CU-UP may transmit a cluster configuration complete message to the CU-CP (S2365). The cluster configuration complete message may indicate that switching of a transmission path is completed. The CU-CP that receives the cluster configuration complete message may transmit a cluster change indication to DUs (S2370).

The S-CU-UP may forward data to the T-CU-UP (S2375). The data forwarding by the S-CU-UP may include at least one of a UL packet that has not yet been transmitted to the core network or a DL packet that has not yet been transmitted to the DU or terminal. The network may transmit an end marker packet to the S-CU-UP (S2380). The terminal and the network may perform communication through a new transmission path (S2385).

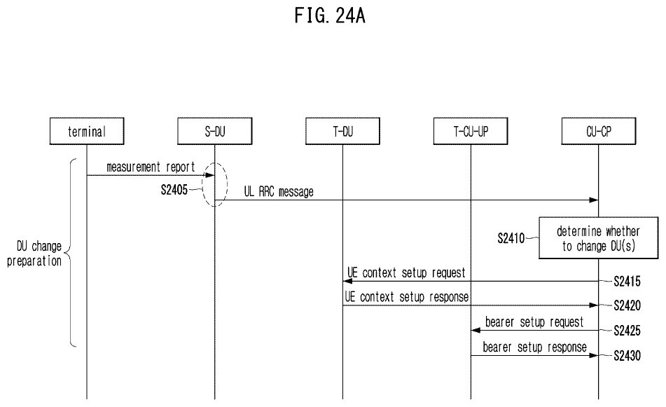

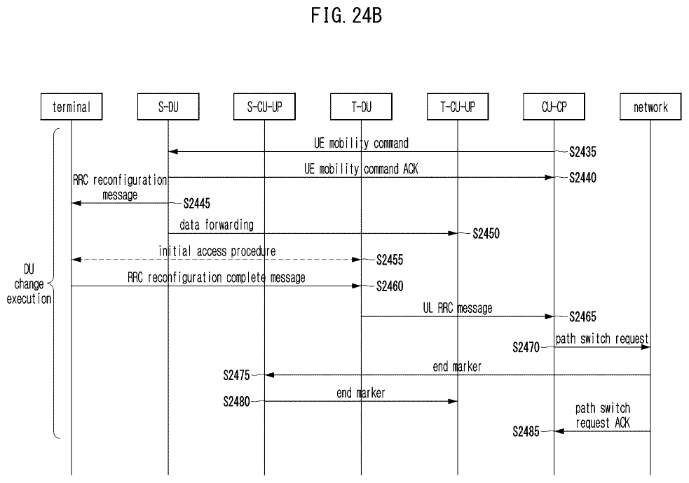

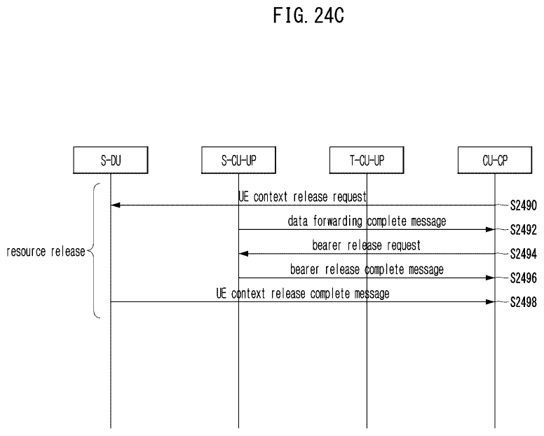

FIG. 24A to FIG. 24C are sequence diagrams illustrating exemplary embodiments of a DU changing procedure.

Referring to FIG. 24A to FIG. 24C, a terminal may transmit a measurement report to an S-DU (S2405). The measurement report may include cluster performance measurement results. The cluster performance measurement results may include a value indicating quality in the cluster perspective (e.g. quality of a channel between TRPs belonging to the cluster and the terminal, or a frequency at which beam switching occurs within the cluster). The S-DU may deliver a UL RRC message to the CU-CP (S2405).

The CU-CP may determine whether to change DU(s) based on the measurement report (S2410). When the CU-CP determines DU change, the CU-CP may determine a T-DU among DUs. The CU-CP may transmit a UE context setup request to the T-DU (S2415). The UE context setup request may include cluster configuration information. The cluster configuration information may include at least one of a cluster ID, a DU group ID, a TRP group ID, a T-CU-UP, a transmission mode (e.g. DL transmission mode), or a multi-connectivity technique applied to the cluster. After receiving the UE context setup request, the T-DU may transmit a UE context setup response to the CU-CP (S2420). The CU-CP may transmit, to the T-CU-UP, a bearer setup request based on the cluster (S2425). In other words, the bearer setup request may include bearer configuration information. The bearer configuration information may be information for configuring cluster-level bearer(s) reflecting at least one of the cluster ID, the DU group, the TRP group, or the transmission mode. After receiving the bearer setup request and based on the cluster configuration information, the T-CU-UP may perform bearer configuration. After completing bearer configuration, the T-CU-UP may transmit a bearer setup response to the CU-CP (S2430).

The CU-CP may transmit a UE mobility command to the S-DU (S2435). The UE mobility command may include cluster configuration information. The cluster configuration information may include at least one of a cluster ID, a DU group, a TRP group, a CU-UP, a transmission mode (e.g. DL transmission mode), or a multi-connectivity technique applied to the cluster. The cluster configuration information may include neighboring cell information. The neighboring cell information may indicate cells that are targets of measurement of the terminal among cells adjacent to the terminal. The neighboring cell information may be transmitted to the S-DU irrespective of the cluster configuration information. After receiving the UE mobility command, the S-DU may transmit a UE mobility command ACK to the CU-CP (S2440).

The S-DU may transmit an RRC reconfiguration message to the terminal (S2445). The RRC reconfiguration message may include cluster configuration information. The cluster configuration information may include at least one of a cluster ID, a DU group, a TRP group, a CU-UP, a transmission mode (e.g. UL transmission mode), or a multi-connectivity technique applied to the cluster. The DU group included in the cluster configuration information may include the T-DU. The CU-UP included in the cluster configuration information may be the T-CU-UP. The cluster configuration information may include neighboring cell information. The neighboring cell information may indicate cells that are targets of measurement of the terminal among cells adjacent to the terminal. The neighboring cell information may be transmitted to the terminal irrespective of the cluster configuration information. The terminal may perform transmission path switching based on the cluster configuration information.

The CU-CP may transmit an SN status to the T-CU-UP. The SN status may be obtained from the S-DU or the S-CU-UP. For example, the SN status may be obtained from the UE mobility command ACK received from the S-DU.

The S-DU may forward data to the T-CU-UP (S2450). The terminal and the T-DU may perform an initial access procedure (S2455). The terminal may transmit an RRC reconfiguration complete message to the T-DU (S2460). The T-DU may deliver a UL RRC message to the CU-CP (S2465). The CU-CP that receives the UL RRC message may transmit a path switch request to the network (S2470). Based on the path switch request, the network may switch a transmission path passing through the S-DU and the S-CU-UP to a transmission path passing through the T-DU and the T-CU-UP. The network that receives the path switch request may transmit an end marker to the S-CU-UP (S2475). The S-CU-UP that receives the end marker may deliver the end marker to the T-CU-UP (S2480). The network may transmit a path switch request ACK to the CU-CP (S2485).

The CU-CP may transmit a UE context release request to the S-DU (S2490). The S-CU-UP may transmit a data forwarding complete message to the CU-UP (S2492). The CU-CP may transmit a bearer release request (S2494). The S-CU-UP may transmit a bearer release complete message (S2496). The S-DU may transmit a UE context release complete message to the CU-CP (S2498).

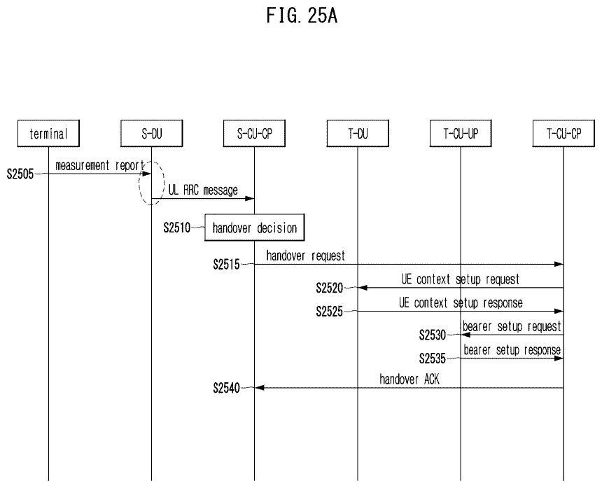

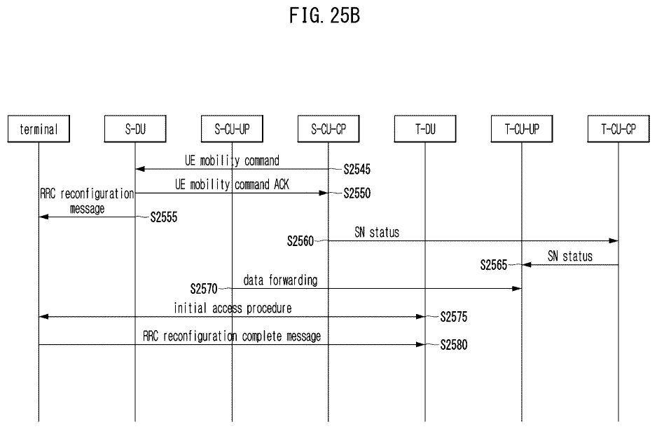

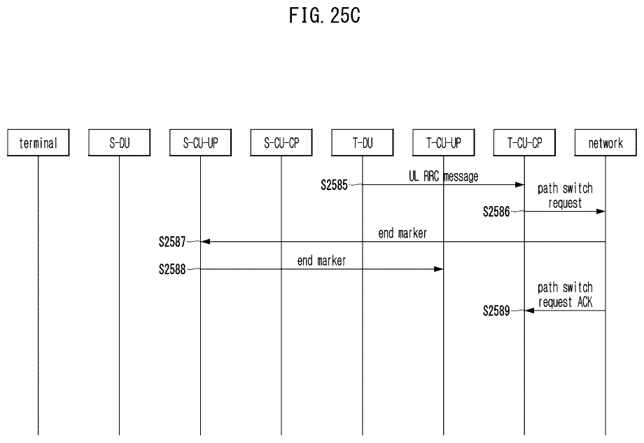

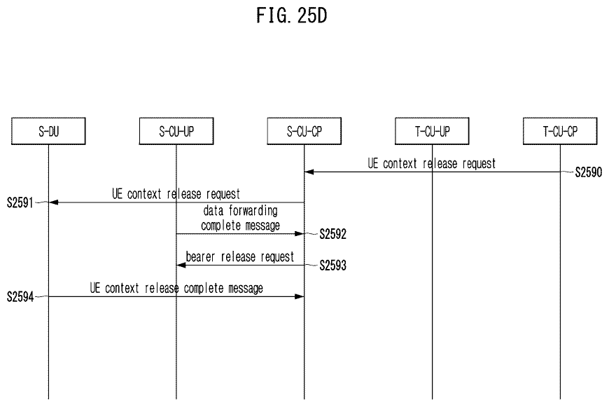

FIG. 25A to FIG. 25D are sequence diagrams illustrating exemplary embodiments of a handover procedure.

Referring to FIG. 25A to FIG. 25D, the terminal may transmit a measurement report to the S-DU (S2505). The measurement report may include cluster performance measurement results. The cluster performance measurement results may include a value indicating quality from the cluster perspective (e.g. quality of a channel between TRPs belonging to a cluster and the terminal, or a frequency at which beam switching occurs within the cluster). The S-DU that receives the measurement report may deliver a UL RRC message to the S-CU-CP (S2505). The S-CU-CP may determine whether to perform handover based on the measurement report (S2510).

The S-CU-CP that determines to perform handover may determine a base station to which the T-CU-CP belongs as a target base station. The S-CU-CP may transmit a handover request to the T-CU-CP (S2515). The handover request may include cluster information. The cluster information may be information of the currently configured cluster. The cluster information may include at least one of the cluster ID, a DU group ID, a TRP group ID, or an S-CU-UP. The T-CU-CP that receives the handover request may determine a cluster for providing service to the terminal. The T-CU-CP may generate cluster configuration information based on the determined cluster. The T-CU-CP may transmit a UE context setup request to the T-DU (S2520). The UE context setup request may include the cluster configuration information. The cluster configuration information may include at least one of a cluster ID, a DU group ID, a TRP group ID, or a T-CU-UP ID.

The T-DU that receives the UE context setup request may transmit a UE context setup response to the T-CU-CP (S2525). The T-CU-CP may transmit a bearer setup request based on the cluster to the T-CU-UP (S2530). In other words, the bearer setup request may include bearer configuration information. The bearer configuration information may be information for configuring a cluster-level bearer reflecting at least one of the cluster ID, the DU group, the TRP group, or the transmission mode. The T-CU-UP that receives the bearer setup request may configure a bearer based on the cluster. The T-CU-UP that completes bearer configuration may transmit a bearer setup response to the T-CU-CP (S2535).

The T-CU-CP that receives the bearer setup response may transmit a handover ACK to the S-CU-CP (S2540). The handover ACK may include cluster configuration information. The cluster configuration information may include at least one of neighboring cell information or a transmission mode. The neighboring cell information may indicate cells that are targets of measurement of the terminal among cells adjacent to the terminal. The neighboring cell information may be transmitted to the S-CU-CP irrespective of the cluster configuration information.

The S-CU-CP may transmit a UE mobility command to the S-DU (S2545). The UE mobility command may include cluster configuration information. The cluster configuration information may include at least one of a transmission mode or neighboring cell information. The S-DU that receives the UE mobility command may transmit a UE mobility command ACK to the S-CU-CP (S2550). The S-DU may transmit an RRC reconfiguration message to the terminal (S2555). The RRC reconfiguration message may include cluster configuration information. The cluster configuration information may include at least one of the neighboring cell information or the transmission mode. The terminal may perform transmission path switching based on the cluster configuration information.

The S-CU-CP may transmit an SN status to the T-CU-CP (S2560). The T-CU-CP may deliver the SN status to the T-CU-UP (S2565). The S-CU-UP may forward data to the T-CU-UP (S2570). The terminal may perform an initial access procedure with the T-DU (S2575). The terminal may transmit an RRC reconfiguration complete message to the T-DU (S2580). The T-DU may deliver a UL RRC message to the T-CU-CP (S2585). The T-CU-CP may transmit a path switch request to the network (S2586). The network that receives the path switch request may change the transmission path from ‘S-DU—S-CU-UP—S-CU-CP’ to ‘T-DU—T-CU-UP—T-CU-CP’. The network may transmit an end marker to the S-CU-UP (S2587). The S-CU-UP that receives the end marker may deliver the end marker to the T-CU-UP (S2588). The network that completes path switching may transmit a path switch request ACK to the T-CU-CP (S2589).

The T-CU-CP may transmit a UE context release request to the S-CU-CP. The S-CU-CP that receives the UE context release request may deliver the UE context release request to the S-DU. The S-CU-UP may transmit a data forwarding complete message to the S-CU-CP. The S-CU-CP that receives the data forwarding complete message may transmit a bearer release request to the S-CU-UP. The S-DU may transmit a UE context release complete message to the S-CU-CP.

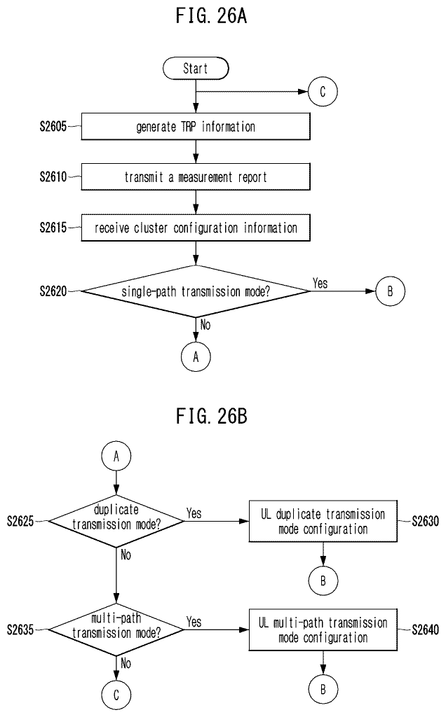

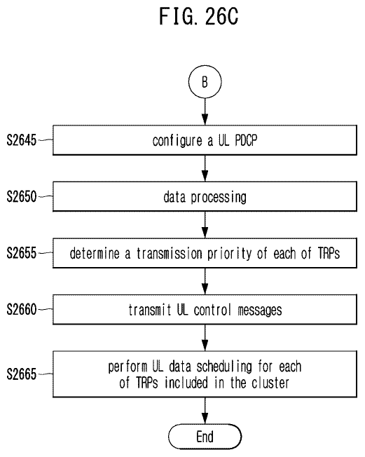

FIG. 26A to FIG. 26C are flowcharts illustrating exemplary embodiments of a UL transmission mode configuration procedure.

Referring to FIG. 26A to FIG. 26C, a terminal may generate TRP information (S2605). The TRP information may include information associated with each TRP adjacent to the terminal (e.g. channel quality information of a channel between the TRP and the terminal, or a TRP ID). The terminal may transmit a measurement report including the TRP information to the network (S2610). The terminal may receive cluster configuration information generated based on the measurement report from the network (S2615). The cluster configuration information may indicate a UL transmission mode. The terminal may perform UL transmission mode configuration according to the UL transmission mode indicated by the cluster configuration information.

The terminal may identify whether the UL transmission mode indicated by the cluster configuration information is a single-path transmission mode (S2620). When the UL transmission mode indicated by the cluster configuration information is a single-path transmission mode, the terminal may perform UL PDCP configuration (S2645). The UL PDCP configuration may be at least one of a configuration on which transmission path a terminal-side PDCP entity transmits a UL PDU through, or a configuration on how the terminal-side PDCP entity transmits the UL PDU. For example, the UL PDCP configuration may be at least one of a configuration on which transmission path transmits the UL PDU, or a configuration on which TRP or DU group is used as a transmission path according to the configured UL transmission mode. For example, the configuration on how the terminal-side PDCP entity transmits the UL PDU may be a configuration on a transmission scheme for the UL PDU (e.g. duplicate transmission or split transmission). When the UL transmission mode is configured as a duplicate transmission mode, the transmission scheme for the UL PDU may be duplicate transmission. When the UL transmission mode is configured as a multi-path transmission mode, the transmission scheme for the UL PDU may be split transmission.

After completing the UL PDCP configuration, the terminal may perform data processing (S2650). After completing the data processing, the terminal may determine transmission priorities among TRPs (S2655). After determining the transmission priorities, the terminal may transmit a UL control message to the network (S2660). The terminal may perform UL data scheduling for each TRP belonging to the cluster (S2665). The UL data scheduling may be performed based on at least one of the UL transmission mode or the transmission priorities of the TRPs. The UL data scheduling may be at least one of determining through which TRP data is transmitted, or determining at which time the data is transmitted.

The terminal may identify whether the UL transmission mode indicated by the cluster configuration information is the duplicate transmission mode (S2625). When the UL transmission mode indicated by the cluster configuration information is the duplicate transmission mode, the terminal may perform UL duplicate transmission mode configuration (S2630). The terminal that completes the UL duplicate transmission mode configuration may perform procedures illustrated in S2645 to S2665. The terminal may identify whether the UL transmission mode indicated by the cluster configuration information is the multi-path transmission mode (S2635). When the UL transmission mode indicated by the cluster configuration information is the multi-path transmission mode, the terminal may perform UL multi-path transmission mode configuration. The terminal that completes the UL multi-path transmission mode configuration may perform procedures illustrated in S2645 to S2665.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
transmitting a measurement report to a first base station;
receiving, from the first base station, first cluster configuration information generated based on the measurement report; and
performing communication with the first base station based on a first cluster configured by the first cluster configuration information.

2. The method according to claim 1, further comprising: performing communication with the first base station based on a second cluster before transmitting the measurement report,
wherein the measurement report includes cluster performance measurement results of the second cluster.

3. The method according to claim 2, wherein the cluster performance measurement results include at least one of: channel quality information of a channel between the terminal and each of transmission and reception points (TRPs) belonging to the second cluster, or a frequency of occurrence of beam-level handovers occurring in an area of the second cluster.

4. The method according to claim 1, wherein the first cluster configuration information includes at least one of: a cluster identifier of the first cluster, a group of TRPs included in the first cluster, a group of distributed units (DUs) included in the first cluster, an uplink (UL) transmission mode, or a multi-connectivity technique applied to the first cluster.

5. The method according to claim 4, wherein the cluster identifier includes at least one of: a central unit-control plane (CU-CP) identifier, a central unit-user plane (CU-UP) identifier, or a DU group identifier.

6. The method according to claim 4, wherein the UL transmission mode indicates one of a duplicated transmission mode, a multi-path transmission mode, or a single-path transmission mode.

7. The method according to claim 1, further comprising: performing communication with the first base station based on a second cluster using a second UL transmission mode before transmitting the measurement report,
wherein the first cluster configuration information includes a first UL transmission mode, and a switching from the second UL transmission mode to the first UL transmission mode is determined by the first base station based on the measurement report.

8. The method according to claim 1, wherein the performing of the communication with the first base station comprises:
performing transmission mode configuration based on a UL transmission mode indicated by the first cluster configuration information;
performing uplink data scheduling for TRPs belonging to the first cluster based on transmission priorities among the TRPs; and
performing communication with the first base station via the TRPs based on the uplink data scheduling.

9. The method according to claim 1, further comprising: performing communication with the first base station based on a second cluster including a second CU-UP before transmitting the measurement report,
wherein the first cluster configuration information includes information on a first CU-UP, and the first CU-UP is determined based on the measurement report.

10. The method according to claim 1, further comprising: performing communication with the first base station based on a second cluster including a second DU before transmitting the measurement report,
wherein the first cluster configuration information includes information on a first DU, and the first DU is determined based on the measurement report.

11. The method according to claim 1, further comprising:
transmitting cluster performance measurement results of the first cluster to the first base station;
receiving third cluster configuration information from the first base station; and
performing a handover to a third base station including a third DU indicated by the third cluster configuration information.

12. A method of a first base station, comprising:
receiving a measurement report from a terminal;
determining first cluster configuration information based on the measurement report;
transmitting the first cluster configuration information to the terminal; and
performing communication with the terminal based on a first cluster configured by the first cluster configuration information.

13. The method according to claim 12, further comprising: performing communication with the terminal based on a second cluster before receiving the measurement report,
wherein the measurement report includes performance measurement results of the second cluster.

14. The method according to claim 13, wherein the cluster performance measurement results include at least one of: channel quality information of a channel between the terminal and each of transmission and reception points (TRPs) belonging to the second cluster, or a frequency of occurrence of beam-level handovers occurring in an area of the second cluster.

15. The method according to claim 12, wherein the first cluster configuration information includes at least one of: a cluster identifier of the first cluster, a group of TRPs included in the first cluster, a group of distributed units (DUs) included in the first cluster, an uplink (UL) transmission mode, or a multi-connectivity technique applied to the first cluster.

16. The method according to claim 15, wherein the cluster identifier includes at least one of: a central unit-control plane (CU-CP) identifier, a central unit-user plane (CU-UP) identifier, or a DU group identifier.

17. The method according to claim 15, wherein the UL transmission mode indicates one of a duplicate transmission mode, a multi-path transmission mode, or a single-path transmission mode.

18. The method according to claim 12, further comprising:
performing communication with the terminal based on a second cluster using a second UL transmission mode before receiving the measurement report; and
determining, based on the measurement report, a switching from the second UL transmission mode to a first UL transmission mode,
wherein the first cluster configuration information includes the first UL transmission mode, and communication based on the first cluster is performed based on the first UL transmission mode.

19. The method according to claim 12, further comprising:
performing communication with the terminal based on a second cluster including a second distributed unit (DU) before receiving the measurement report; and
determining, based on the measurement report, a change from the second DU to a first DU,
wherein the first cluster configuration information includes information on the first DU.

20. The method according to claim 12, further comprising:
receiving cluster performance measurement results of the first cluster from the terminal;
determining whether to perform a handover based on the measurement report; and
transmitting, to a second base station, a handover request including cluster information of the first cluster based on the determination of whether to perform the handover.
